(19) United States
(12) Patent Application Publication
(10) Pub. No.: US 2024/0281710 A1
(43) Pub. Date: Aug. 22, 2024

(54) HANDLING MULTI-LOOP FEEDBACK FOR MACHINE LEARNING MODEL PIPELINES

(71) Applicant: Abridge AI, Inc., Pittsburgh, PA (US)

(72) Inventors: Shivdev Rao, Pittsburgh, PA (US); Sandeep Konam, Pittsburgh, PA (US)

(21) Appl. No.: 18/443,826

(22) Filed: Feb. 16, 2024

Related U.S. Application Data
(60) Provisional application No. 63/447,418, filed on Feb. 22, 2023.

(51) Int. Cl. G06N 20/00

(52) U.S. Cl. CPC G06N 20/00

(57) ABSTRACT

Handling multi-loop feedback for machine learning model (MLM) pipelines may be provided by receiving annotations regarding an analysis output of the MLM for a recorded natural language conversation, wherein the annotations include at least a first and second corrections to corresponding first and second errors in the analysis output; identifying, corresponding first and second sub-models of the plurality of sub-models that are responsible for the respective first and second errors, wherein the first sub-model occurs earlier in the sequential pipeline than the second sub-model; determining whether the second sub-model, when provided with a first corrected output from the first sub-model based on the first correction produces the second correction as part of a second corrected output from the second model; and in response to determining that the second model produces the second corrected output, retraining only the first sub-model based on the first correction.

### BACKGROUND

Machine Learning (ML) is a branch of Artificial Intelligence (AI) directed to developing AI models that continuously improve or “learn” based on training data to make predictions (and take corresponding actions) on new data. Machine Learning Models (MLM) are used in a variety of applications, including in Natural Language Processing (NLP) for computer systems to understand freeform text and spoken words. Human speech, despite various grammatical rules, is generally unstructured, as there are myriad ways for a human to express one concept using natural language. Accordingly, processing human speech into a structured format usable by computing systems is a complex task for NLP systems to perform, and one that calls for great accuracy if the output of the NLP systems is to be trusted by human users for sensitive tasks.

### SUMMARY

The present disclosure is generally related to Artificial Intelligence (AI) and User Interface (UI) design and implementation useful for the analysis of transcripts of spoken natural language conversations.

The present disclosure provides methods and apparatuses (including systems and computer-readable storage media) to interact with various Machine Learning Models (MLM) trained to convert spoken utterances to written transcripts and summaries of those transcripts as part of a Natural Language Processing (NLP) system. As an MLM is only as accurate as the training data used to teach that MLM, the present disclosure provides for faster and more efficient data collection and organization for the training and retraining of various MLMs. Various UIs are provided to annotators to elicit feedback on the analysis output of the MLM. These UIs are formatted to prioritize correction of various potential errors of greater importance to the MLM model or the end-user, and highlight the underlying data used by the MLM to reach the analysis output under review.

To improve the efficiency of the process, the UI may avoid or remove elements for review when an earlier edit to a portion of the analysis output is determined to affect a downstream analysis in pipeline for the MLM. Additionally or alternatively, the UI may add or highlight elements for review when an earlier edit to a portion of the analysis output is determined to affect a downstream analysis in pipeline for the MLM. For example, when a transcript includes two elements for review for accuracy, when the UI highlights the first element and an auditor provides an edits for the first element, the UI can remove the second element for display (e.g., because the edit to the first element would change how the MLM produced the second element) and/or highlight a third element for display (e.g., because the edit to the first element would change how the MLM produced the third element) to receive confirmation or edits from an auditor.

In the UI, an auditor can indicate whether an element of the analysis output is already correct or make corrections to that element. The UI, as part of the correction process, provides information about the inputs or related elements that the MLM used to generate the elements under analysis, which may benefit the annotator's analysis. Additionally, in the same UI, the auditor can indicate (as part of the feedback for the MLM) different portions of the analysis output that the MLM should use when analyzing the data. For example, when dealing with ambiguous pronouns, the UI can identify a base noun that it believes is related to the pronoun, and the auditor can accept or correct which base noun a pronoun is associated with.

Accordingly, the present disclosure is generally directed to increasing and improving the functionality, efficiency, and usability of the underlying computing systems and MLMs via the various methods and apparatuses described herein via an improved UI.

One embodiment of the present disclosure is a method to perform various operations, a system including a processor and a memory including instructions that when executed by the processor perform various operations, and a memory device that includes instructions that when executed by a processor perform various operations for training a machine learning model (MLM) that has a plurality of sub-models arranged in a sequential pipeline, the operations comprising: receiving annotations regarding an analysis output of the MLM for a recording of a natural language conversation, wherein the annotations include at least a first correction to a first error in the analysis output and a second correction to a second error in the analysis output; identifying, a first sub-model of the plurality of sub-models that is responsible for the first error and a second sub-model of the plurality of sub-models that is responsible for the second error, wherein the first sub-model occurs earlier in the sequential pipeline than the second sub-model; determining whether the second sub-model, when provided with a first corrected output from the first sub-model based on the first correction produces the second correction as part of a second corrected output from the second model; and in response to determining that the second model produces the second corrected output, retraining only the first sub-model based on the first correction.

One embodiment of the present disclosure is a method to perform various operations, a system including a processor and a memory including instructions that when executed by the processor perform various operations, and a memory device that includes instructions that when executed by a processor perform various operations, the operations comprising: presenting, via a user interface (UI), an analysis output of a natural language conversation created by a machine learning model (MLM); in response to a user indicating a first error and a second error in the analysis output via the UI, identifying a first initial evidence and a second initial evidence in a transcript included in the analysis output, wherein the first initial evidence was used by the MLM to generate the first error and the second initial evidence was used by the MLM to generate the second error; prompting, via the UI, for the user to indicate a first feedback that includes: a first correction to the first error, a first category of the first error, and a first timestamp in the natural language conversation for a first corrective evidence supporting the first correction to replace the first error, wherein the first corrective evidence is different from the first initial evidence; prompting, via the UI, for the user to indicate a second feedback that includes: a second correction to the second error, a second category of the second error, a second timestamp in the natural language conversation for a second corrective evidence supporting the second correction to replace the second error, wherein the second corrective evidence is different from the second initial evidence; and in response to identifying that first correction affects at least one of the second initial evidence and the second corrective evidence, providing the first feedback as a corrective example for retraining the MLM.

One embodiment of the present disclosure is a method to perform various operations, a system including a processor and a memory including instructions that when executed by the processor perform various operations, and a memory device that includes instructions that when executed by a processor perform various operations, the operations comprising: collecting a training dataset for a machine learning model (MLM) for generating an analysis output of a natural language conversation, the MLM comprising a plurality of sub-models arranged in a sequential pipeline, the training dataset including a plurality of example corrections to previous analysis outputs generated by the MLM; for each example included in the training dataset: determining which sub-model of the plurality of sub-models each example provides a correction to; determining whether an initial input for each example is affected by an upstream correction indicated in a different example that provides an altered input to the sub-model according to the different correction; designating in the training dataset: a negative training example when the initial input is not affected by the different correction; a positive training example when the initial input is affected by the different correction and the sub-model that the example provides the correction to produces equivalent outputs when analyzing the initial input and the altered input; and an ignored training example when the initial input is affected by the correction and the sub-model that the example provides the correction to produces different outputs when analyzing the initial input and the altered input; and retraining the MLM using the training dataset.

### BRIEF DESCRIPTION OF THE DRAWINGS

The accompanying figures depict various elements of the one or more embodiments of the present disclosure, and are not considered limiting of the scope of the present disclosure.

In the Figures, some elements may be shown not to scale with other elements so as to more clearly show the details. Additionally, like reference numbers are used, where possible, to indicate like elements throughout the several Figures.

It is contemplated that elements and features of one embodiment may be beneficially incorporated in the other embodiments without further recitation or illustration. For example, as the Figures may show alternative views and time periods, various elements shown in a first Figure may be omitted from the illustration shown in a corresponding second Figure without disclaiming the inclusion of those elements in the embodiments illustrated or discussed in relation to the second Figure.

FIG. 1 illustrates an example environment that an auditing User Interface can be provided, according to embodiments of the present disclosure.

FIG. 2 illustrates a computing environment, according to embodiments of the present disclosure.

FIG. 3 illustrates an editing pipeline generator, according to embodiments of the present disclosure.

FIG. 4 illustrates a pipelined MLM during an annotating process that handles multi-loop feedback for the pipelined MLM, according to embodiments of the present disclosure.

FIGS. 5A-5D illustrate interactions with an annotating User Interface that displays a transcript and summaries thereof identified from a conversation, according to embodiments of the present disclosure.

FIGS. 6A-6F illustrate interactions with an annotating User Interface that displays a transcript and summaries thereof identified from a conversation, according to embodiments of the present disclosure.

FIG. 7 is a flowchart of an example method for handling multi-loop feedback for machine learning model pipelines, according to embodiments of the present disclosure.

FIG. 8 is a flowchart of an example method for handling multi-loop feedback for machine learning model pipelines, according to embodiments of the present disclosure.

FIG. 9 is a flowchart of an example method for handling multi-loop feedback for machine learning model pipelines, according to embodiments of the present disclosure.

FIG. 10 illustrates an example computing device, according to embodiments of the present disclosure.

### DETAILED DESCRIPTION

Because transcripts of spoken conversations are becoming increasingly important in a variety of fields, the accuracy of those transcripts and the accuracy of interpreted elements extracted from those transcripts is also increasing in importance. Accordingly, accuracy in the transcript affects the accuracy in the later analyses, and greater accuracy in transcription and analysis improves the usefulness of the underlying systems used to generate the transcript and analyses thereof.

To create these transcripts and the analyses thereof, the present disclosure describes a Natural Language Processing (NLP) system. As used herein, NLP is the technical field for the interaction between computing devices and unstructured human language for the computing devices to be able to “understand” the contents of the conversation and react accordingly. An NLP system may be divided into a Speech Recognition (SR) system, that generates a transcript from a spoken conversation, and an analysis system, that extracts additional information from the written record (e.g., from a transcript generated by the SR system or an edited version of such a transcript). In various embodiments, the NLP system may use separate Machine Learning Models (MLMs) for each of the SR system and the analysis system, or may use one MLM to handle the SR tasks and the analysis tasks.

To train the NLP system to perform within specified parameters in interpreting a conversation that the NLP system has not previously interacted with, the MLM is trained based on previously observed conversations and edits (e.g., by a human annotator). Training an MLM is a time consuming process that consumes signification computational resources and may be performed over several iterations to constantly improve the operations of the MLM. To streamline the training process, and provide more relevant training data (thereby conserving computing resources and resulting in improved functionality in the resulting MLM, among other benefits), the present disclosure provides for handling multi-loop feedback for pipelined MLMs. Because not every edit to the transcript or summary results in valuable feedback, and particular edits may be more valuable or applicable to different sub-models in the MLMs, the present disclosure provides for Graphical User Interfaces (GUIs) to easily elicit feedback from annotators that divides the feedback into classifications or subsets for specific types of errors, and the pipeline of sub-models in the MLM is used to judge whether the edit would have been made if other errors identified by the annotator (via other edits) had not initially been made by the MLM. Accordingly, various edits may be handled in different ways to improve the functionality of the MLM, thereby avoiding duplicative or needless retraining operations and using an improved training dataset to more quickly arrive at an improved MLM with reduced risk of overfitting the model to the training data or training the model on spurious training data.

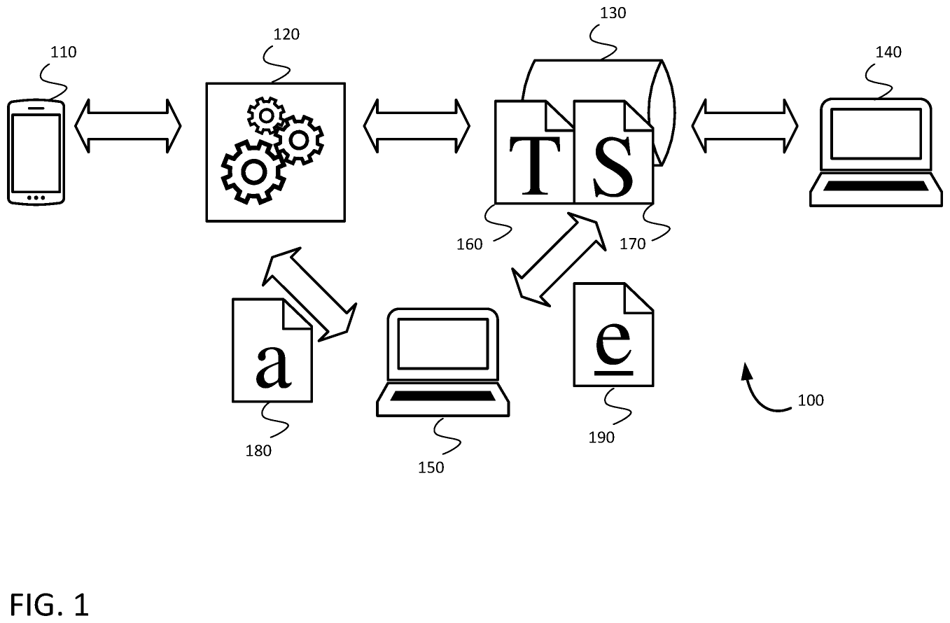

FIG. 1 illustrates an example environment 100 in which an annotating User Interface (UI) can be provided, according to embodiments of the present disclosure. A shown in FIG. 1, a recording device 110 in in communication with an NLP system 120 to convert a spoken natural language conversation captured by the recording device 110 into a transcript 160 and various associated summaries 170 of the transcript 160, which are stored in a database 130.

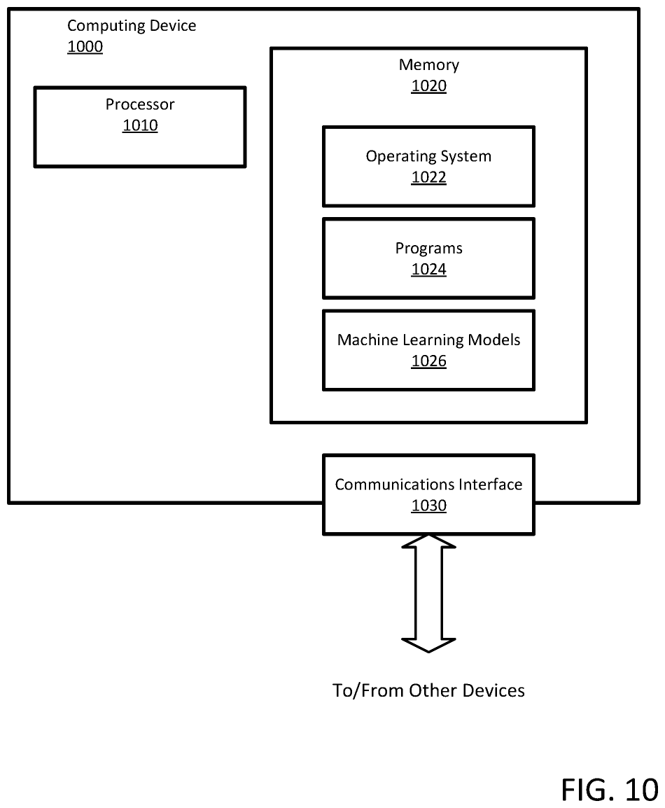

In various embodiments, the recording devices 110 may be any device (e.g., such as the computing device 1000 described in relation to FIG. 10) that is capable of recording the audio of the conversation, which may include cellphones, dictation devices, laptops, tablets, personal assistant devices, or the like. In various embodiments, the recording device 110 may transmit the conversation according to various file formats (e.g., WAV, AIFF, FLAC, ATRAC, ALC, WMA, etc.) for processing to a remote service (e.g., via a telephone or data network), locally store or cache the recording of the conversation for later processing (locally or remotely), or combinations thereof. In various embodiments, the recording device 110 may pre-process the recording of the conversation to remove or filter out environmental noise, compress the audio, remove undesired sections of the conversation (e.g., silences or user-indicated portions to remove), which may reduce data transmission loads or otherwise increase the speed of transmission of the conversation over a network.

In various embodiments, the transcripts 160 and summaries 170 may be provided to a consuming device 140 for an end user to consume the transcript 160 and summaries 170, and to an annotating device 150 for an annotating user (e.g., an annotator) to review and edit the transcript 160 or summary 170. In addition to receiving the transcripts 160 and summaries 170 from the database 130, the annotating device 150 is also in communication with the NLP system 120 to send and receive annotations 180 to improve the annotator's ability to make edits 190 to the transcripts 160 and summaries 170 stored in the database 130. In various embodiments, the consuming device 140 and the annotating device 150 may be different devices used by different users, the same device used by the same users but in different modes, and variations thereof. In various embodiments, the consuming device 140 and the annotating device 150 may be any device (e.g., such as the computing device 1000 described in relation to FIG. 10) that is capable of sending and receiving digital files for reading/playback and manipulating (e.g., editing) those digital files, which may include cellphones, dictation devices, laptops, tablets, personal assistant devices, or the like.

Recording and transcribing conversations related to healthcare, technology, academia, or various other esoteric topics can be particularly challenging for NLP systems 120 due to the low number of example utterances that include related terms, the inclusion of jargon and shorthand used in the particular domain, the similarities in phonetics of markedly different terms within the domain (e.g., lactase vs. lactose), similar terms having certain meanings inside of the domain that are different from or more specific than the meanings used outside of the domain, mispronunciation or misuse of domain terms by non-experts speaking to domain experts, and other challenges. Accordingly, the annotating device 150 is provided, in some instances, to a human user acting as a Human-in-the-Loop (HiL) or reviewer to provide corrections, notes, suggesting, and feedback to the machine learning models (MLMs) used by the NLP system 120 and to correct any errors or note any ambiguities in the transcripts 160 and summaries 170.

The present disclosure therefore provides for UIs that allow annotators to more readily interact with the transcripts 160 and summaries 170 and to expose various processes of the NLP systems 120 and MLMs that produced the transcripts 160 or summaries 170. The annotator is also enabled to use the NLP systems 120 and MLMs thereof as an editing tool for the specified context of a transcript 160 or summary 170 currently being annotated, rather than a generalized context for all transcripts/summaries produced by the NLP system 120 or annotated previously by the annotating device 140, thereby improving data privacy for the annotation process.

Although the present disclosure primarily uses example conversations related to a healthcare visit as a basis for the examples discussed herein, the present disclosure may be used for the provision and manipulation of data gleaned from conversations related to various topics outside of the healthcare space (e.g., equipment maintenance, education, law, agriculture, etc.). Additionally, although the example conversations and analyzed terms discussed herein are primarily provided in English, the present disclosure may be applied for transcribing and annotating a variety of languages with different vocabularies, grammatical rules, word-formation rules, and use of tone to convey complex semantic meanings and relationships between words.

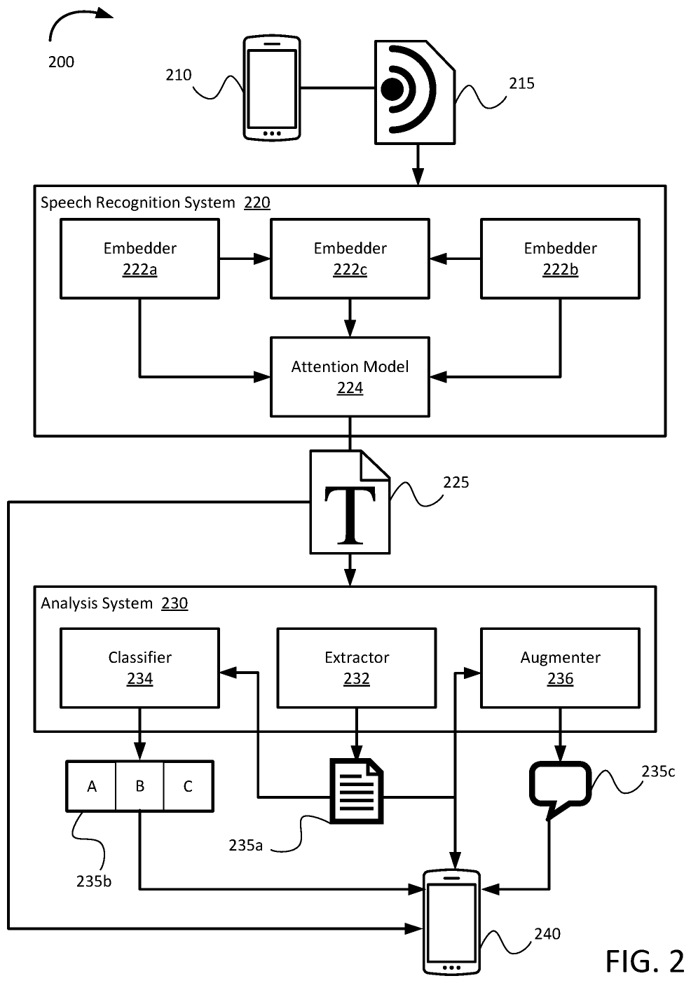

FIG. 2 illustrates a computing environment 200, according to embodiments of the present disclosure. The computing environment 200 may represent a distributed computing environment that includes multiple computers, such as the computing device 1000 discussed in relation to FIG. 10, interacting to provide different elements of the computing environment 200 or may include a single computer that locally provides the different elements of the computing environment 200. Accordingly, some or all of the elements illustrated with a single reference number or object in FIG. 2 may include several instances of that element, and individual elements illustrated with one reference number or object may be performed partially or in parallel by multiple computing devices.

The computing environment 200 includes an audio provider 210, such as a recording device 110 described in relation to FIG. 1, that provides a recording 215 of a completed conversation or individual utterances of an ongoing conversation to a Speech Recognition (SR) system 220 to identify the various words and intents within the conversation. The SR system 220 provides a transcript 225 of the recording 215 to an analysis system 230 to identify and analyze various aspects of the conversation relevant to the participants. As used herein, the SR system 220 and the analysis system 230 may be jointly referred to as an NLP system.

As received, the recording 215 may include an audio file of the conversation, video data associated with the audio data (e.g., a video recording of the conversation vs. an audio-only recording), as well as various metadata related to the conversation, and may also include video data. For example, a user account associated with the audio provider 210 may serve to identify one or more of the participants in the conversation, or append metadata related to the participants. For example, when a recording 215 is received from an audio provider 210 associated with John Doe, the recording 215 may include metadata that John Doe is a participant in the conversation. The user of the audio provider 210 may also indicate that the conversation took place with Erika Mustermann, (e.g., to provide the identity of another speaker not associated with the audio provider 210), when the conversation took place, whether the conversation is complete or is ongoing, where the conversation took place, what the conversation concerns, or the like.

The SR system 220 receives the recording 215 and processes the recording 215 via various machine learning models to convert the spoken conversation into various words in textual form. The models may be domain specific (e.g., trained on a corpus of words for a particular technical field) or general purpose (e.g., trained on a corpus of words for general speech patterns). In various embodiments, the SR system 220 may use an Embedding from Language Models (ELMo) model or a Bidirectional Encoder Representation from Transformers (BERT) model or other machine learning models to convert the natural language spoken audio into a transcribed version of the audio. In various embodiments, the SR system 220 may use Transformer networks, a Connectionist Temporal Classification (CTC) phoneme based model, a Listen Attend and Spell (LAS) grapheme based model, or any other models to convert the natural language spoken audio into a transcribed version of the audio. In some embodiments, the analysis system 230 may be a large language model.

Converting the spoken utterances to a written transcript not only matches the phonemes to corresponding characters and words, but also uses the syntactical and grammatical relationship between the words to identify a semantic intent of the utterance. The SR system 220 uses this identified semantic intent to select the most correct word in the context of the conversation. For example, the words “there”, “their”, and “they're” all sound identical in most English dialects and accents, but convey different semantic intents, and the SR system 220 selects one of the options for inclusion in the transcript for a given utterance. Accordingly, an attention model 224, is used to provide context of the various different candidate words among each other. The selected attention model 224 can use a Long Short Term Memory (LSTM) architecture or Transformers to track relevancy of nearby words on the syntactical and grammatical relationships between words at a sentence level or across sentences (e.g., to identify a noun introduced in an earlier utterance related to a pronoun in a later utterance).

The SR system 220 can include one or more embedders 222a-c (generally or collectively embedder 222) to embed further annotations to the transcript 225, such as, for example by including: key term identifiers, timestamps, segment boundaries, speaker identifies, and the like. Each embedder 222 may be a trained MLM to identify various features in the audio recording 215 and/or transcript 225 that are used for further analysis by an attention model 224 or extraction by the analysis system 230.

For example, a first embedder 222a is trained to recognize key terms, and may be provided with a set of words, relations between words, or the like to analyze the transcript 225 for. Key terms may be defined to include various terms (and synonyms) of interest to the users. For example, in a medical domain, the names of various medications, therapies, regimens, syndromes, diseases, symptoms, etc., can be set as key terms. In a maintenance domain, the names of various mechanical or electrical components, assurance tests, completed systems, locational terms, procedures, etc., can be set as key terms. In another example, time based words may be identified as candidate key terms (e.g., Friday, tomorrow, last week). Once recognized in the text of the transcript, a key term embedder 222 may embed a metadata tag to identify the related word or set of words as a key term, which may include tagging pronouns associated with a noun with the same metadata tags as the associated noun.

A second embedder 222b can be used by the SR system 220 to recognize different participants in the conversation. In various embodiments, individual speakers may be distinguished by vocal patterns (e.g., a different fundamental frequency for each speaker's voice), loudness of the utterances (e.g., identifying different locations relative to a recording device), or the like.

In another example, a third embedder 222c is trained to recognize segments within a conversation. In various embodiments, the SR system 220 diarizes the conversation into portions that identify the speaker, and provides punctuation for the resulting sentences (e.g., commas at short pauses, periods at longer pauses, question marks at a longer pause preceded by rising intonation) based on the language being spoken. The third embedder 222c may then add metadata tags for who is speaking a given sentence (as determined by the second embedder 222b) and group one or more portions of the sentence together into segments based on one or more of a shared theme or shared speaker, question breaks in the conversation, time period (e.g., a segment may be between X and Y minutes long before being joined with another segment or broken into multiple segments), or the like.

When using a shared theme to generate segments, the SR system 220 may use some of the key terms identified by a key term embedder 222 via string matching. For each of the detected key terms identifying a theme, the segment identifying embedder 222 selects a set of nearby sentences to group together as a segment. For example, when a first sentence uses a noun, and a second sentence uses a pronoun for that noun, the two sentences may be grouped together as a sentence. In another example, when a first person provides a question, and a second person provides a responsive answer to that question, the question and the answer may be grouped together as a segment. In some embodiments, the SR system 220 may define a segment to include between X and Y sentences, where another key term for another segment (and the proximity to the second key term to the first) may define ab edge between adjacent segments.

Once the SR system 220 generates a transcript 225 of the identified words from the recording 215, the SR system 220 provides the transcript 225 to an analysis system 230 to generate various analysis outputs 235 from the conversation. In various embodiments, the operations of the SR system 220 are separately controlled from the operations of the analysis system 230, and the analysis system 230 may therefore operate on a transcript 225 of a written conversation or a human-generated transcript (e.g., omitting the SR system 220 from the NLP system or substituting a non-MLM system for the SR system 220). The SR system 220 may directly transmit the transcript 225 to the output device 240 (before or after the analysis system 230 has analyzed the transcript 225), or the analysis system 230 may transmit the transcript 225 to the output device 240 on behalf of the SR system 220 once analysis is complete.

The analysis system 230 may use an extractor 232 to generate readouts 235a of the key points to provide human-readable summaries of the interactions between the various identified key terms from the transcript. These summaries include the identified key terms (or related synonyms) and are formatted according to factors for sufficiency, minimality, and naturalness. Sufficiency defines a characteristic for a key point that, if given only the annotated span, a reader should be able to predict the correct classification label for the key point, which encourages longer key points that cover all distinguishing or background information needed to interpret the contents of a key point. Minimality defines a characteristic for a key point that identifies peripheral words which can be replaced with other words without changing the classification label for the key point, which discourages marking entire utterances as needed for the interpretation of a key point. Naturalness defines a characteristic for a key point that, if presented to a human reader should sound like a complete phrases in the language used (or as a meaningful word if the key point has only a single key term) to avoid dropping stop words from within phrases and reduce the cognitive load on the human who uses the NLP system's extraction output.

For example, when presented with a series of sentences from the transcript 225 related to how frequently a user should replace a battery in a device, and what type of battery to use, the extractor 232 may analyze several sentences or segments to identify relevant utterances spoken by more than one person to arrive at a summary. The readout 235a may recite “Replace battery; Every year; Use nine volt alkaline” to provide all or most of the relevant information in a human-readable format that was gathered from a much larger conversation.

A category classifier 234 included in the analysis system 230 may operate in conjunction with the extractor 232 to identify various categories 235b that the readouts 235a belong to. In various embodiments, the categories 235b include several different classifications for different users with different review goals for the same conversation. In various embodiments, the category classifier 234 determines the classification based on one or more context vectors developed via the attention model 224 of the SR system 220 to identify whether a given segment or portion of the conversation belongs to which category (including a null category) out of a plurality of potential categories that a user can select from the system to classify portions of the conversation into.

The analysis system 230 may include an augmenter 236 that operates in conjunction with the extractor 232 to develop supplemental content 235c to provide with the transcript 225. In various embodiments, the supplemental content 235c can include callouts of pseudo-key terms based on inferred or omitted details from a conversation, hyperlinks between key points and semantically relevant segments of the transcript, links to (or provides the content for) supplemental or definitional information to display with the transcript, calendar integration with extracted terms, or the like.

For example, when the extractor 232 identifies terms related to a planned follow up conversation (e.g., “I will call you back in thirty minutes”), the augmenter 236 can generate supplemental content 235c that includes a calendar invitation or reminder in a calendar application associated with one or more of the participants that a call is expected thirty minutes from when the conversation took place. Similarly, if the augmenter 236 identifies terms related to a planned follow up conversation that omits temporal information (e.g., “I will call you back”), the augmenter 236 can generate a pseudo-key term to treat the open-ended follow up as though an actual follow up time had been set (e.g., to follow up within a day or set a reminder to provide a more definite follow up time within a system-defined placeholder amount of time).

In various embodiments, when generating supplemental content 235c of a hyperlink between an extracted key point and a segment from the transcript, the augmenter 236 links the most-semantically-relevant segment with the key point, to allow users to navigate to relevant portions of the transcript 225 via the key points. As used herein, the most-semantically-relevant segment refers to the one segment that provides the greatest effect on the category classifier 234 choosing to select one category for the key point, or the one segment that provides the greatest effect on the extractor 232 to identify the key point within the context of the conversation. Stated differently, the most-semantically-relevant segment is the portion of the conversation that has the greatest effect on how the analysis system 230 interprets the meaning and importance of the key point within the conversation.

Additionally, the augmenter 236 may generate or provide supplemental content 235c for defining or explaining various key terms to a reader. For example, links to third-party webpages to explain or provide pictures of various unfamiliar terms, or details recalled from a repository associated with a key term dictionary, can be provided by the augmenter 236 as supplemental content 235c.

The augmenter 236 may format the hyperlink to include the primary target of the linkage (e.g., the most-semantically-relevant segment), various secondary targets to use in updating the linkage based on user feedback (e.g., a next-most-semantically-relevant segment), and various additional effects or content to call based on the formatting guidelines of various programming or markup languages.

Each of the extractor 232, category classifier 234, and the augmenter 236 may be separate MLMs or different layers within one MLM provided by the analysis system 230. Similarly, although illustrated in FIG. 2 with separate modules for an extractor 232, classifier 234, and augmenter 236, in various embodiments, the analysis system 230 may omit one or more of the extractor 232, classifier 234, and augmenter 236 or combine two or more of the extractor 232, classifier 234, and augmenter 236 in a single module. Additionally, the flow of outputs and inputs between the various modules of the analysis system 230 may differ from what is shown in FIG. 2 according to the design of the analysis system 230. When training the one or more MLMs of the analysis system 230, the MLMs may be trained via a first inaccurate supervision technique, such as via fine tuning a large language model, and subsequently by a second incomplete supervision technique to fine-tune the inaccurate supervision technique and thereby avoid catastrophic forgetting. Additional feedback from the user may be used to provide supervised examples for further training of the MLMs and better weighting of the factors used to identify relevancy of various segments of a conversation to the key points therein, and how those key points are to be categorized for review.

The analysis system 230 provides the analysis outputs 235 to an output device 240 for storage or output to a user. In some embodiments, the output device 240 may be the same or a different device from the audio provider 210. For example, a caregiver may record a conversation via a cellphone as the audio provider 210, and receive and interact with the transcript 225 and analysis outputs 235 of the conversation via the cellphone. In another example, the caregiver may record a conversation via a cellphone as the audio provider 210, and receive and interact with the transcript 225 and analysis outputs 235 of the conversation via a laptop computer.

In various embodiments, the output device 240 is part of a cloud storage or networked device that stores the transcript 225 and analysis outputs 235 for access by other devices that supply matching credentials to allow for access on multiple endpoints.

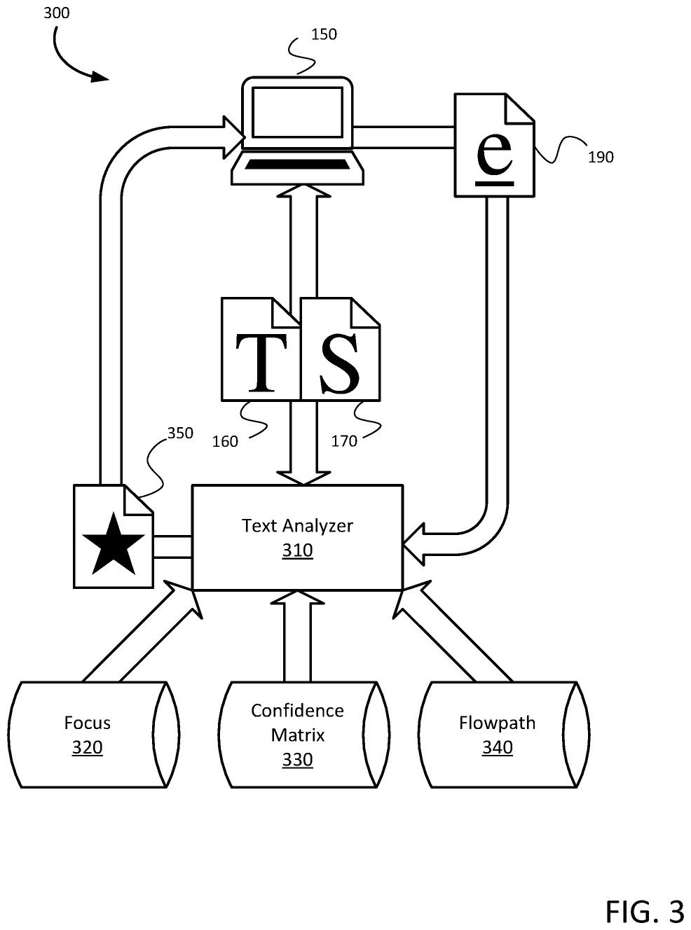

FIG. 3 illustrates an editing pipeline generator 300, according to embodiments of the present disclosure. In various embodiments, the editing pipeline generator 300 is provided as an MLM and the associated modules of computer executable code to identify various action items to follow up on based on a conversation and the information included or omitted therefrom.

A text analyzer 310 accesses a focus database 320, a confidence matrix 330, and an analysis flowpath 340 to determine which terms to emphasize during an annotation session of the transcript 160 and summaries 170 to focus an annotators attention to or away from.

In various embodiments, the text analyzer 310 accesses the user-defined focus database 320 to identify which terms or classes of terms that an end-user has designated as having higher or lower priorities for accurate transcription or summarization relative to other terms or classes of terms. For example, a first user may place greater emphasis for the correctness of terminology in the transcript 160 related to medication names than for other terminology. Accordingly, with other factors being equal, the text analyzer 310 emphasizes the medication names found in the transcript 160 to an annotator before, or to a greater extent, than other terms found in the transcript 160 to ensure that the annotator verifies correct transcription of these terms from the original conversation.

In various embodiments, the text analyzer 310 accesses the confidence matrix 330 received from the MLM used to generate the transcript 160 that identifies various confidences in transcribing terms from the spoken conversation to the written transcript 160 to emphasize terms with lower confidence before, or a greater extent, than terms having higher confidence in transcription. For example, the MLM may have a 90% confidence in a first term being an accurate transcription of the corresponding portion of the conversation and a 95% confidence in a second term being an accurate transcription of the corresponding portion of the conversation, and the confidence matrix 330 therefore indicates to the text analyzer 310 to, with other factors being equal, emphasize the first term before, or to a greater extent than, the second term is emphasized.

Similarly, the confidence matrix 330 also indicates, in some embodiments, the confidence of the MLM used to generate the summaries 170 in how accurate of the summaries 170 represent all or a portion of the transcript 160. Accordingly, the text analyzer 310 can emphasize summaries 170 or terms in the summaries 170 with lower confidence before, or a greater extent, than terms having higher confidence. For example, the MLM may have a 50% confidence in a first summary 170 being an accurate representation of the corresponding portion of the conversation (e.g., due to an ambiguous reading of the transcript 160) and a 95% confidence in a second summary being an accurate representation of a different portion of the conversation, which may be determined independently of the confidence of the MLM in the accuracy of the transcript 160 on which the summaries 170 are based. In the present example, the confidence matrix 330 indicates to the text analyzer 310 that, with other factors being equal, the first summary 170 should be emphasized before, or to a greater extent than, the second summary 170 is emphasized.

In various embodiments, the text analyzer 310 access the analysis flowpath 340 received from the MLM used to generate the transcript 160 to prioritize emphasis of upstream terms or downstream terms in the editing process. As used herein, upstream and downstream identify where an element exists in the flow of generating the transcript 160 and summaries 170 relative to other elements, which may be independent of the order of the terms in the flow of the conversation. In a pipelined MLM, various modules rely on determinations or inputs that are determined “upstream” of a certain module (e.g., by sub-model that occurs earlier in the pipeline) and produce outputs that are used “downstream” of that certain module (e.g., by a sub-model that occurs later in the pipeline). For example, because a summary 170 is generated based on the transcript 160 of the conversation, a summary 170 may generally be considered to be downstream of the portions of the transcript 160 that the summary 170 represents. Similarly, a transcription sub-model may be considered to be upstream of a summarization sub-model in a sequential pipeline of operations in the MLM.

As used herein, “upstream” and “downstream” do not necessarily refer to an order in which terms appear in the conversation. For example, a first utterance that refers to an object as a pronoun (e.g., “I like it”, with “it” being the pronoun in question) followed by a second utterance that clarifies what the pronoun refers to (e.g., “I mean, I like the color”, with “color” being identified as being represented by “it”), can result in the earlier utterance being considered downstream of the later utterance. The later utterance is upstream of the earlier utterance in this example because the MLM uses the later utterance to analyze and assign semantic meaning to the earlier pronoun, thereby using the second utterance as an input to determine how to interpret the first utterance. Similarly, because the summaries 170 exist outside of the flow of the conversation, the summaries 170 may be considered downstream of the transcript 160 without having a particular order related to the conversational flow.

In some embodiments, when receiving edits to the transcript 160 or summary 170, the text analyzer 310 may place earlier or greater emphasis on errors (or potential errors) that are more upstream compared to other errors that are produced by modules more downstream in the pipeline. For example, all other factors being equal, the text analyzer 310 may initially place greater emphasis on a potential error in the transcript 160 than a potential error in a downstream summary 170, which may be affected by the potential error in the transcript 160.

The text analyzer 310 considers some or all of factors from the focus database 320, confidence matrix, 330, and flowpath 340 when generating an emphasis registry 350 based on various weightings of these factors. Accordingly, although several examples have been given with a caveat of all other factors being equal, these factors may be unequal in practice. The emphasis registry 350 may be included as metadata in the transcript 160 and summaries 170 or as a separate file that identifies portions of the transcript 160 and summaries 170 to be emphasized in the annotator's UI.

In some embodiments, the emphasis registry 350 may define various levels or categories of emphasis that the UI on the annotator device 150 is to apply as user-mapped effects to the transcript 160 or summary 170 (e.g. according to various user preferences), or may specify certain effects to apply to emphasize (or deemphasize) various portions of the transcript 160 or summary 170. These effects may include changes in typeface (e.g., Time New Roman versus Arial), font effects (e.g., bold, underline, italic, strikethrough), text colors, background colors, animations, text sizes, bounding boxes, and combinations thereof. These effects, when applied in the UI, help draw the annotator's attention towards certain portions of the transcript 160 and summaries 170 according to the weightings set via the focus database 320, confidence matrix 330, and analysis flowpath 340.

As the annotator makes edits 190 to the transcript 160 or summary 170, the edits 190 may be provided to the text analyzer 310 to update the emphasis registry 350. For example, after the annotator provides an annotation for a first potential error (e.g., providing a correction or marking as correct) associated with an emphasis in the emphasis registry 350, the text analyzer 310 can generate an updated emphasis registry 350 that removes or alters the effect applied to the first potential error, and may re-rank the other emphases in the emphasis registry 350 based on the update transcript 160 or summary 170. For example, after marking a portion of the transcript 160 as correct, the text analyzer 310 may reduce the level of emphasis placed on downstream elements to the portion of the transcript 160 (e.g., sections of the summary 170 generated based on that portion of the transcript 160). In another example, after marking a portion of the transcript 160 as incorrect and updating the transcript 160 with a correction, the text analyzer 310 may increase the level of emphasis placed on downstream elements (e.g., related sections of the summary 170 generated using the now outdated transcript 160).

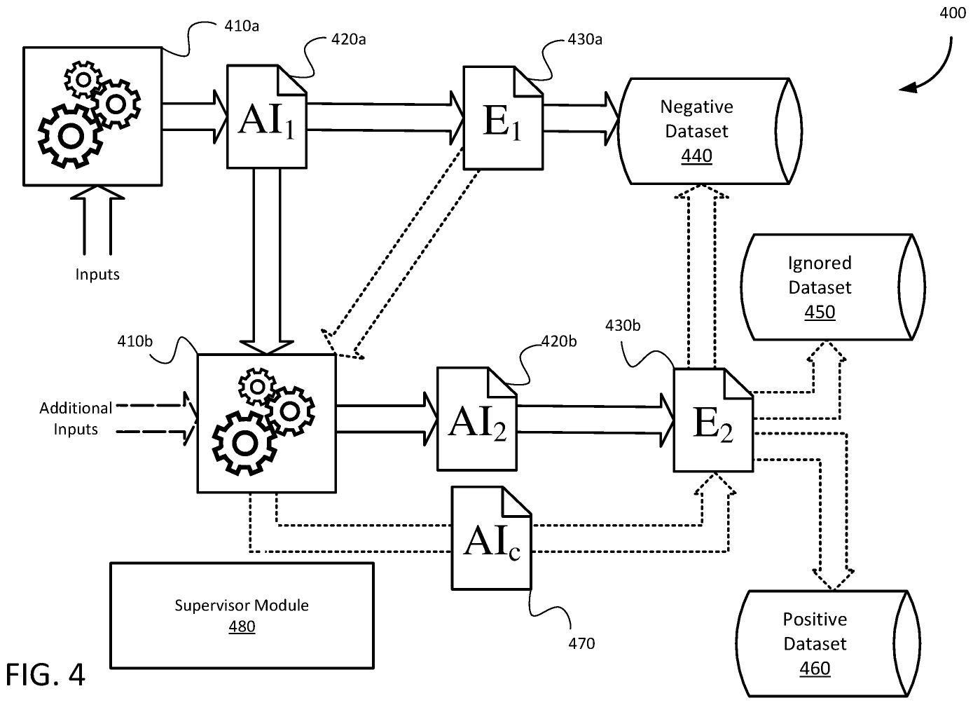

FIG. 4 illustrates a pipelined MLM 400 during an annotating process that handles multi-loop feedback for the pipelined MLM 400, according to embodiments of the present disclosure. A first sub-model 410a (generally or collectively, sub-model 410) produces a first analysis output 420a (generally or collectively, analysis output 420) that is used as an input (which may be one input of many) for a second sub-model 410b to produce a second analysis output 420b. In the illustrated example, the second sub-model 410b is downstream of the first sub-model 410a, and the second analysis output 420b is downstream of the first analysis output 420a. Stated differently, in the illustrated example, the first sub-model 410a is upstream of the second sub-model 410b, and the first analysis output 420a is upstream of the second analysis output 420b.

During an annotating process, an annotator makes a first edit to the first analysis output 420a to produce a first corrected output 430a (generally or collectively, corrected output 430) and a second edit to the second analysis output 420b to produce a second corrected output 430b. The edits may include modifications to terms, deletions of terms, insertions of terms, re-associations between terms (e.g., which noun a pronoun refers to), and re-orderings of terms, which may be made to sections of a transcript 160 or summary 170 highlighted by the system for annotation or others sections manually selected by the annotator.

In various embodiments, a supervisor module 480, which may be part of the pipelined MLM 400 or a separate routine or program, monitors the editing process and determines the relevancy of various edits provided to the analysis outputs 430 of the pipelined MLM 400 to the various components of the pipelined MLM 400, how to classify or handle the various feedback, and whether to re-train one or more elements or sub-models 410 in the pipelined MLM 400 using some or all of the received feedback and/or previously collected feedback.

Once an edit is made is made to an associated analysis output 420, that edit or the corrected output 430 can be added to a negative dataset 440 for retraining the associated sub-model 410. Accordingly, the sub-model 410 can be retrained using the negative dataset 440 to avoid generating the same error when similar inputs are provided to the sub-model 410 in the future if including the dataset for training improves the operation of the MLM 400. However, because the pipelined MLM 400 uses various outputs from upstream sub-models 410 as inputs that potentially affect the outputs of the downstream sub-models 410, not every edit or corrected output 430 should be used as a negative example. Stated differently, when the pipelined MLM 400 uses an erroneous input in a downstream sub-model 410, the sub-model 410 may be accurately trained even though an erroneous analysis output 420 was initially generated. Accordingly, the pipelined MLM 400 identifies when an erroneous analysis output 420 used inputs that received edits, and verifies whether the error in the analysis output 420 was due to poor inputs, poor training of the sub-model 410, or combinations thereof before deciding how to handle the edits for retraining the sub-models 410.

Although positive, ignored, and negative examples are discussed as examples for dividing a training dataset, other divisions and sub-divisions of the example dividing criteria are also contemplated. For example, recency of the examples, language used in the examples, speaker classifications, domains or subjects of the conversation, and other criteria can be used in addition to or instead of positive/negative/ignored as dividing criteria.

In the illustrated example, the second sub-model 410b uses the first analysis output 420a as at least one input to produce the second analysis output 420b, which both were edited. Accordingly, for the pipelined MLM 400 to determine whether the second corrected output 430b should be used as part of negative dataset 440, an ignored dataset 450, or a positive dataset 460 for retraining the second sub-model 410b, the pipelined MLM 400 determines whether the error in the second analysis output 420b is due the operations of the second sub-model 410b or the upstream first sub-model 410a. In various embodiments, the pipelined MLM 400 uses the first corrected output 430a along with any other additional inputs (including any edits thereto), to produce a candidate analysis output 470 to compare against the second corrected output 430b. The comparison between the candidate analysis output 470 and the second corrected output 430b allows the pipelined MLM 400 to determine whether the second sub-model 410b, if it had been initially provided with the correct output from the first sub-model 410a (rather than the erroneous initial first analysis output 420a) would produce a similar output to the edits made by the annotator. In various embodiments, the pipelined MLM 400 may use various fuzzy matching or fuzzy logic algorithms (which one of ordinary skill in the relevant art will be familiar with) to determine whether the candidate analysis output 470 matches the corrected analysis output 430. In some embodiments, the pipelined MLM 400 may use exact matching (as opposed to fuzzy matching) to determine whether the candidate analysis output 470 matches the corrected analysis output 430, so that the MLM 400 is trained over time to produce analysis outputs 420 that more closely mimic the style and substance of the human annotator's edits.

For example, a candidate analysis output 470 of “The dog ate dinner quickly” would be an exact match to a corrected output 430 of “The dog ate dinner quickly” and would be a fuzzy match (according to a certain fuzzy matching algorithm) of a corrected output 430 of “The dog quickly ate dinner” or “The hound devoured the food rapidly at night” as the example phrases convey the same semantic meaning.

When the candidate analysis output 470 matches the corrected output 430, the pipelined MLM 400 may add the corrected output 430 to an ignored dataset 450 or a positive dataset 460. The positive dataset 460 includes examples that are to be used for retraining the sub-models 410 to reinforce accurate production of analysis outputs 420, while the ignored dataset 450 includes examples that are not used for retraining the sub-models 410.

In various embodiments, the ignored dataset 450 and the positive dataset 460 are different states of the same dataset; an operator can choose to use examples from the dataset, rendering it the positive dataset 460, or to not use examples from the dataset (or not retrain the associated sub-model 410), rendering it the ignored dataset 450. In some embodiments, the pipelined MLM 400 keeps separate entries in each of the positive dataset 460 and ignored dataset 450. For example, the pipeline MLM 400 can assign exact matches to the positive dataset 460, and fuzzy matches to the ignored dataset 450, or can assign downstream correct analysis outputs 420 (e.g., unedited or marked by an annotator as correct) that have upstream inputs that were corrected (e.g., were edited) to the positive dataset 460 and downstream incorrect analysis outputs 420 (e.g., that were edited by the annotator) that have upstream inputs that were corrected (e.g., were edited) to the ignored dataset 450.

In some embodiments, the negative dataset 440 or the ignored dataset 450 include edits that are not usable or edits to off topic sections of the conversation. For example, in a conversation between a physician and a patient, the conversation may start with small talk that is unrelated (e.g., off topic) to the main topic of the conversation of the patient's health (e.g., the weather, upcoming holiday plans, whether family members are feeling well) that may receive edits, but are of no interest to how the main conversation should be interpreted.

Although the edits and associated data points are generally described as being separated into the various datasets, the entries in the datasets may be linked to other entries in the same or different datasets. For example, if a first sentence and a second sentence are initially classified as related to topic A, and the annotator changes the class of the second sentence to be related to topic B, the edit may be treated different based on whether the model handles the sentences independently or as linked elements. Accordingly, when the model treats the example sentences independently, the first sentence can be added to the positive dataset 460, and the second sentence can be added to a negative dataset 440 for recognizing sentences belonging to topic A (vice versa for topic B). However, when the model uses a sequence of data including both sentences as input (e.g., linking the sentences to provide additional context) the first sentence and the second sentence (as a linked set of elements based on the model's inputs/outputs) may be added to one or multiple of the negative dataset 440, the ignored dataset 450, and the positive dataset 460.

In various embodiments, when the current iteration of a sub-model 410 already produces analysis outputs 420 that are correct (or would have been correct if correct inputs had been provided), the machine learning model can conserve computing resources (e.g., processor cycles) by not retraining the sub-models 410 that do not have new entries to the negative dataset 440.

The annotator-edit actions are added to the respective datasets to improve the summarization and language recognition models to produce outputs that are closer to how the annotator phrased the corrected terms, which uses both the AI-generated analysis output 420 and the corrected outputs 430. Similarly, in some embodiments, the MLM 400 uses other annotator actions for classification or other modules or sub-models 410 that are a part of the MLM 400. While training with the AI-generated analysis outputs 420, the sub-models 410 are trained to lower the probability of producing words at a location from which an annotator deleted or modified words (for the corresponding input and output), and to improve or maintain the probability of producing words at a location from which the annotator did not change words (for the corresponding input and output). While training with edited/corrected outputs 430, the sub-models 410 are trained to improve the probability of producing words at a location where an annotator added words which were not present in the AI-generated analysis output 420 (for the corresponding input and output), and to improve or maintain the probability of producing words at a location from which the annotator user did not change words in the AI-generated analysis outputs 420 (for the corresponding input and output).

In some embodiments, when using the multi-loop feedback schema described in relation to FIG. 4 to improve the summarization of a transcript via the AI-generated and annotator-edited outputs, the loss functions used to train the sub-models 410 are calculated according to Formulas 1 and 2, where (S_{AI},S_{E}) are the AI-generated and the corresponding user-edited pairs for the summaries 170 from the dataset, (T_{AI+E}, T_{E}) are the transcript regions used as input to train the sub-model 410 when using AI-generated and edited summaries respectively (T_{AI+E} is created considering both TAL and T_{E}), W_{AI-C} is the loss weight to penalize the edited words in the AI-generated summary, W_{AI-NC} and W_{E-NC} are the loss weights to encourage the model to produce words that were not edited in the AI-generated and the edited summaries, W_{E-NC} is the loss weight to encourage the model to produce words that are edited in the edited summaries, 1_{AI-C} (t) is the indicator function to signify if the word xₜ in the AI-generated summary is edited by the annotator, and 1_{AI-NC}(t) signifies when the word is not edited, 1_{E-C}(t) and 1_{E-NC}(t) signify if the word xₜ in the corrected output is edited or not edited by the annotator respectively, L_{penalize}(xₜ|x_{<t}) is a loss function that penalizes the model from producing xₜ, and L_{reward}(xₜ|x_{<t}) is a loss function that encourages the model to produce xₜ.

$${L}_{{S}_{AI}} = {\sum }_{x ∈ {S}_{AI}} ( {1}_{AI - C} ( t ) {w}_{AI - C} {L}_{p e n a l i z e} ( {x}_{t} \vert {x}_{< t} , {T}_{AI + E} ) + {1}_{AI - NC} ( t ) {w}_{AI - NC} {L}_{r e w a r d} ( {x}_{t} \vert {x}_{< t} , {T}_{AI + E} ) ) \qquad Formula 1$$

$${L}_{{S}_{E}} = {\sum }_{x ∈ {S}_{E}} ( {1}_{E - C} ( t ) {w}_{E - C} {L}_{r e w a r d} ( {x}_{t} \vert {x}_{< t} , {T}_{E} ) + {1}_{E - N C} ( t ) {w}_{E - N C} {L}_{r e w a r d} ( {x}_{t} \vert {x}_{< t} , {T}_{E} ) ) \qquad Formula 2$$

In some embodiments, the indicator functions used in Formulas 1 and 2, can be found by tracking the annotator's changes as edits are made or by aligning the edits to the AI-generated analysis outputs 420 using algorithms like the Needleman-Wunsch Algorithm.

When retraining the sub-models 410 using the new data in the above described method, the new examples may be added to an existing corpus of examples in the respective dataset to avoid over-fitting the models or “forgetting” lessons previous learned by the model. Additionally, to avoid over-fitting or forgetting, the values set for various a loss terms can be used to adjust unintended behavior for various special characteristics (e.g., end-of-sentence markers, punctuation, over-shortening summaries, etc.).

In various embodiments, some of the corrections may be added to the ignored dataset 450 when their inclusion may negatively affect the retraining process. For example, when a threshold number (or percentage) of the analysis outputs 420 have corrections, the corrected output 430 is unrelated to the initial AI-generated analysis output 420 (e.g., changes in semantic meaning), or when the annotator links, during the annotating process, different regions of the transcript 160 as evidence for the correction than the initial inputs selected by the sub-model 410.

Although FIG. 4 illustrates two sub-models 410 and the associated outputs for a pipelined MLM 400, in various embodiments, the pipelined MLM 400 may include more sub-models 410 in various configurations. For example, one downstream sub-model 410 may receive inputs from two upstream sub-models 410 that do not directly communicate with one another. In another example, one downstream sub-model 410 may receive an input from an intermediate sub-model 410 that receives an input from an upstream sub-model 410, where the edits and corrected outputs 430 are propagated through the intermediate sub-model 410 and the upstream sub-model 410 to generate a candidate analysis output 470 for comparison against the corrected output 430 of the downstream sub-model 410. In another example, one upstream sub-model 410 may provide outputs to two downstream sub-models 410 that do not directly communicate with one another, and where the edits and corrected outputs 430 for the upstream sub-model 410 are propagated to both of the downstream sub-models 410 for comparison against the corrected output 430 of each of the downstream sub-models 410.

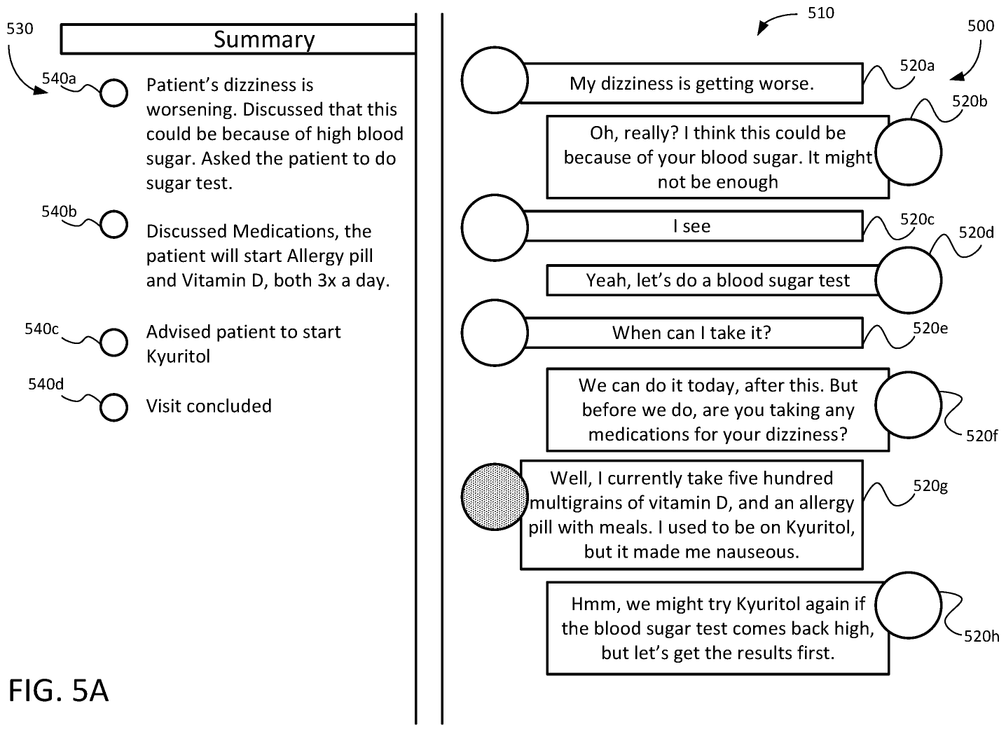

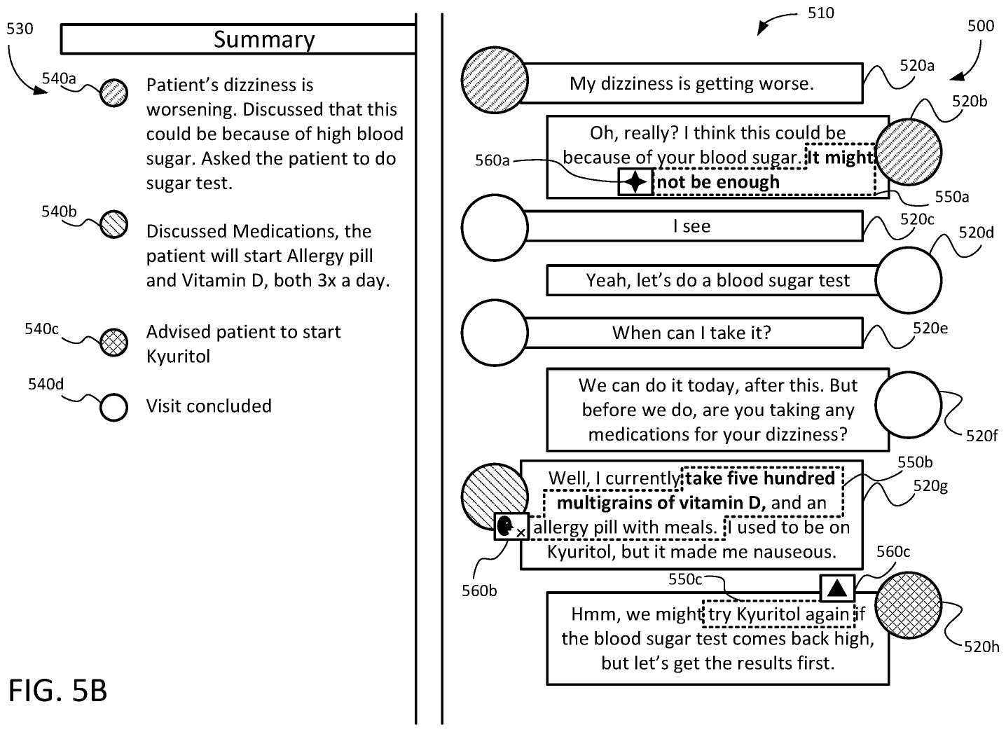

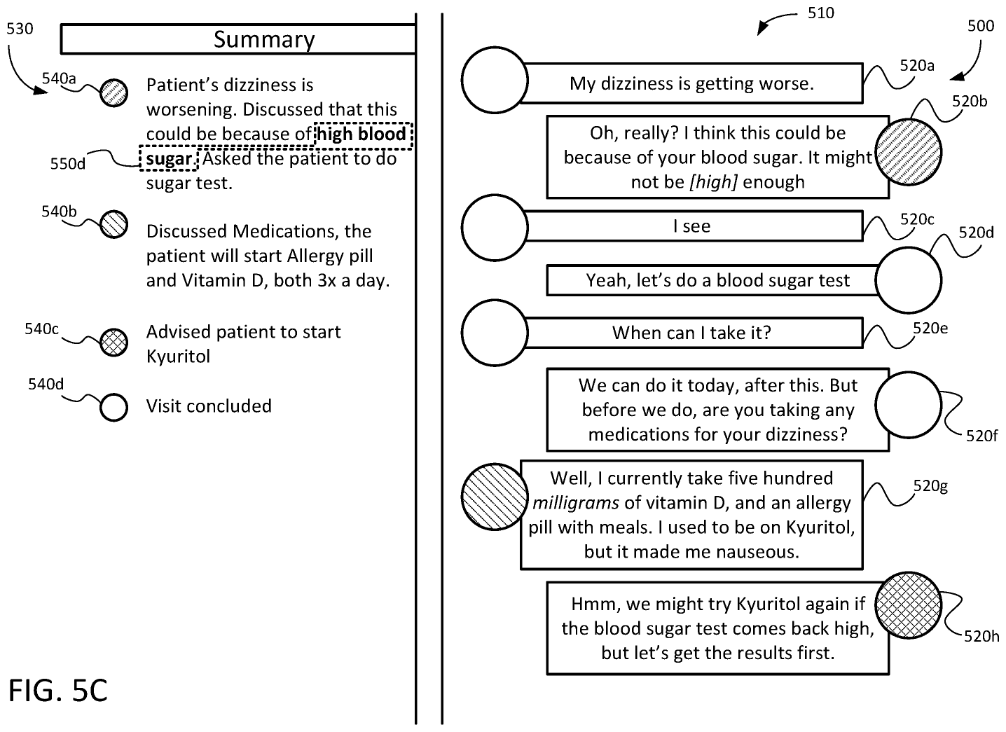

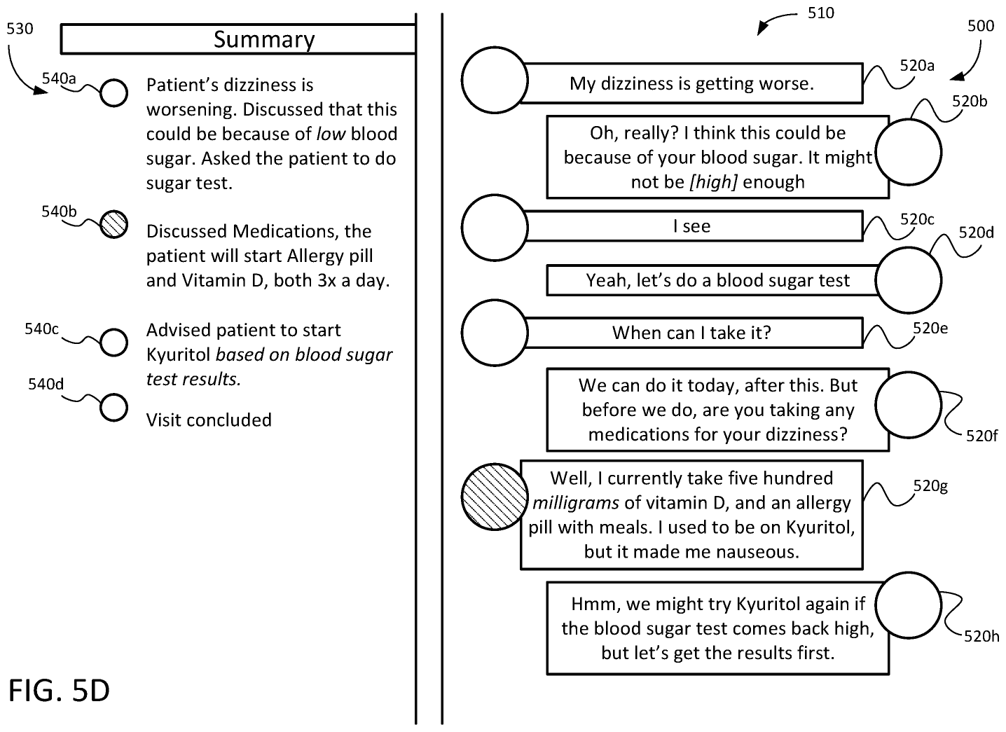

FIGS. 5A-5D illustrate a graphical users interface (GUI) 500 with an annotator editing contents of a transcript 160 and summaries 170 thereof with initial edits made to the transcript 160, according to embodiments of the present disclosure. Using a conversation between a doctor and a patient as a non-limiting example, the GUI 500 illustrated in FIGS. 5A-5D shows a perspective for an annotator adapted interface, but in various embodiments, other conversations may relate to different conversational domains taken from different perspectives than those illustrated in the current example.

FIG. 5A illustrates a first state of the GUI 500, as may be provided to an annotator after initial analysis of an audio recording of a conversation by an NLP system 120. The transcript is shown in a transcript window 510, which includes several segments 520a-520h (generally or collectively, segment 520) identified within the conversation. In various embodiments, the segments 520 may represent speaker turns in the conversation, sentences identified in the conversation, topics identified in the conversation, a given length of time in the conversation (e.g., every X seconds), combinations thereof, and other divisions of the conversation.

Each segment 520 includes a portion of the written text of the transcript 160, and provides a UI element that allows the user to access the corresponding audio recording, make edits to the transcript, zoom in on the text, and otherwise receive additional detail for the selected portion of the conversation. The transcript illustrated in FIGS. 5A-5D may represent an entire conversation or a portion of the transcript such that the GUI 500 may omit portions of the transcript from initial display. For example, the GUI 500 may initially display only the segments 520 from which key terms or candidate terms appear (e.g., to skip introductory remarks or provide a summary), with the non-displayed segments 520 being omitted from display (e.g., positioned “off screen” for later access), shown as thumbnails, etc.

In various embodiments, additional data or metadata related to the segment 520 (e.g., speaker, topic, confidence in written text accurately matching input audio, whether edited by a user) can be presented based on color or shading of the segment 520 or alignment of the segment 520 in the transcript window 510. For example, the first segment 520a, third segment 520c, fifth segment 520e, and seventh segment 520g are shown as left-aligned versus the second segment 520b, fourth segment 520d, sixth segment 520f, and eighth segment 520h, which are shown as right-aligned, which indicates different speakers for the differently aligned segments 520. In another example, the seventh segment 520g is displayed with a different shading than the other segments 520, which may indicate that the NLP system is confident that human error is present in the third segment 320c, that the NLP system is not confident in the transcribed words matching the spoken utterance, or another aspect of the seventh segment 520g that deserves additional attention from the annotator.

Depending on the display area available to present the GUI 500, the transcript window 510 may include some or all of the segments 520 at a given time. Accordingly, although not illustrated, in various embodiments, the transcript window 510 may include various content controls (e.g., scroll bars, text size controls, etc.) to enable access to more content than can be legibly displayed at one time on the device outputting the GUI 500. For example, content controls can allow a user to scroll to currently off-screen elements, zoom in on elements below a size threshold or presented as thumbnails when not selected, or the like.

Outside of the transcript window 510, the GUI 500 displays a summary window 530 with one or more summarized representations 540a-d (generally or collectively, representation 540). The representations 540 provide summarizations of the key points extracted from the conversation and selectable controls that, in response to selection by a user, adjust the display of the segments 520 in the transcript window 510 to highlight the segments 520 on which the selected representation 540 is based. Accordingly, the representations 540 allow for easy navigation of the transcript based on the extracted summaries.

FIG. 5B shows the GUI 500 with emphases applied to phrases in the segments 520, such as may be determined by the text analyzer 310 discussed in greater detail in relation to FIG. 3, to draw an annotator's attention to certain areas for confirmation or correction during the annotation process. These emphases may be displayed according to various effects including increasing the size of the text to emphasize relative to other text, decreasing the size of text to deemphasize (or not emphasize) relative to other text, changing a color of portions of the text, applying a font effect (e.g., bold, underline, strikethrough, italics, and combination thereof), applying an animation, applying a bounding box, changing a color of a background to the text, changing where in the GUI 500 the text is displayed (e.g., centering a viewing window), other like highlighting techniques, and combinations thereof. Additionally, the GUI 500 can display linkages between the portions of the transcript (e.g., in the segments 520) and the summaries (e.g., in the representations 540) that are related to one another to allow the annotator to draw parallels between the transcript 160 and the summaries 170 thereof or more readily identify whether the transcript 160 has been properly summarized by the MLM.

In the illustrated example, the second segment 520b is shown with emphasized text 550a (generally or collectively, emphasized text 550) of “it might not be enough” in boldface within a bounding box with an indicator 560a (generally or collectively indicator 560) for why the associated emphasized text 550a has been emphasized. In the present example, the indicator 560a uses a first shape associated with a gap in the transcript (e.g., due to poor audio, an unintelligible utterance, speaker error, the MLM encountering an unfamiliar phrase that cannot be transcribed with sufficient confidence, etc.). Additionally, the second segment 520b, the first segment 520a, and the first representation 540a are each displayed with a shared pattern (e.g., left-to-right rising stripes) applied as an emphasis to indicate that the first representation 540a includes a summary based on the contents of the first segment 520a and the second segment 520b.

In the illustrated example, the seventh segment 520g is shown with emphasized text 550b of “take five hundred multigrains of vitamin D, and an allergy pill with meals” in boldface with a bounding box with an indicator 560b for why the associated emphasized text 550b has been emphasized. In the present example, the indicator 560b uses a second shape associated with speaker error, in which the MLM is satisfied with the accuracy of the transcription (e.g., a confidence for individual term transcription is above a threshold value) but believe that the speaker used a phrase improperly, such as when the speaker in the seventh segment actually spoke “multigrains” but may have intended to say the more semantically appropriate “milligrams”. Additionally, the seventh segment 520g and the second representation 540b are each displayed with a shared pattern (e.g., left-to-right descending stripes) applied as an emphasis to indicate that the second representation 540b includes a summary based on the contents of the seventh segment 520g.

In the illustrated example, the eighth segment 520h is shown with emphasized text 550b of “try Kyuritol again” with a bounding box with an indicator 560c for why the associated emphasized text 550c has been emphasized. In the present example, the indicator 560c uses a third shape associated with there being no suspected errors in the transcript, but that the emphasized text 550c forms a basis for a summary (e.g., the third representation 540c). Additionally, the eighth segment 520hg and the third representation 540c are each displayed with a shared pattern (e.g., cross-hatching) applied as an emphasis to indicate that the third representation 540c includes a summary based on the contents of the eighth segment 520h.

Although several portions of emphasized text 550 are shown as being identified for individual reasons, in various embodiments, one portion of text can be emphasized for multiple reasons. In various embodiments, different highlighting effects can be used to show that a given portion of text has been emphasized for multiple reasons (e.g., bold for a first emphasis, italics for a second emphasis, with portions affected by the first and second emphases being both bolded and italicized).

FIG. 5C shows the GUI 500 after the annotator has addressed the initially highlighted elements in FIG. 5B and new emphases, such as may be determined by the text analyzer 310 discussed in greater detail in relation to FIG. 3, are applied to draw an annotator's attention to certain areas for confirmation or correction during the annotation process.

In various example, the edits made to the transcript 160 or summaries 170 are differentiated from original content via various effects. In the illustrated example in FIG. 5D, an annotator has added a term to the first segment, which is indicated with the term being held in brackets and being displayed via italicized text to read, in part, “It might not be [high] enough” rather than the original “It might not be enough”. Similarly, the annotator is shown to have edited the seventh segment 520g to read, in part, “I currently take five hundred milligrams of vitamin D” rather than the original “I currently take five hundred multigrains of vitamin D” which indicates the correction to milligrams via an applied italics effect. In each of the examples for the second segment 520b and the seventh segment 520g, the initial emphasis effects of boldface text and bounding boxes are removed once the annotator has made the indicated edits. Similarly, the initial emphasis effects are shown as removed from the eighth segment 520h, which may be in response to the annotator marking the contents of the eighth segment 520h as correct or otherwise not to be edited (e.g., skipped or provided with a note rather than a correction).

As the annotator makes edits to correct errors and omissions, or marks candidate edit targets as being correct or not to be edited, new emphasis effects can be applied to downstream elements affected by an edit or be applied to new elements that previously were not emphasized. For example, the GUI 500 may apply emphasis to up to a threshold number of elements at one time such that the n elements with the highest emphasis score (e.g., as determined by the text analyzer 310) are initially emphasized, and when one element is addressed, the element with the next highest emphasis score (e.g., element n+1) is then emphasized. Additionally or alternatively to using a current version of an emphasis registry 350, and as is described in greater detail in regard to FIG. 3, the annotator device 150 can send the edits 190 to the text analyzer 310 to produce an updated emphasis registry 350, which can provide additional emphasis targets, remove certain emphasis targets, and re-order how the emphasis targets are ranked for the GUI 500 to provide an updated set of up to n emphasized elements in the transcript 160 and summaries 170.

In the illustrated example, in response to the annotator editing the second segment 520b, the GUI 500 removes the emphasis from the initially emphasized elements in the second segment 520b and emphasizes a downstream element in the linked first representation 540a, as the summary 170 that the reason for the patient's dizziness due to blood sugar levels being high/low enough may have been affected by the annotator's edits. Accordingly, the emphasized text 550d of “high blood sugar” is emphasized via a bold text effect and a bounding box to draw the annotator's attention to the newly emphasized elements of the summary 170.

In the illustrated example, in response to the annotator editing the seventh segment 520g, the GUI 500 removes the emphasis from the initially emphasized elements in the seventh segment 520g, which does not result in the downstream summary displayed in the second representation 540b having additional emphasis applied. In some embodiments, the lack of additional emphasis may be the result of the edit to the upstream elements not affecting the output of the sub-model used to generate the summary 170, or the text analyzer 310 determining that the downstream elements are not within the top n entries of the emphasis registry 350 or that the emphasis score for the downstream elements do no satisfy an emphasis threshold for inclusion in the emphasis registry 350.

In the illustrated example, in response to the annotator marking the eighth segment 520h as correct (or otherwise not in need of edits), the GUI 500 removes the emphasis from the initially emphasized elements in the eight segment 520h, which does not result in the downstream summary in the third representation 540c having additional emphasis applied, as no edits were made to the upstream elements used to generate the summary 170 displayed by the third representation 540c.

By applying and removing emphasis according to relationship of the phrases being upstream/downstream to various AI generated elements in a pipelined MLM, the GUI 500 can redirect the annotator's attention to portions of the transcript 160 or summaries 170 that gain importance (and away from portions that lose importance) during the editing process according to the various editing criteria (e.g., as discussed in greater detail in relation to FIG. 3) and encourage the collection of further edits (or affirmations that no edits are needed) to develop a training dataset tailored to the individually affected sub-models in the pipelined MLM.

FIG. 5D shows the GUI 500 after the annotator has addressed the updated highlighted elements in FIG. 5C with additional edits.

In the illustrated example, the annotator has edited the recitation in the first representation 540a that “this could be because of high blood sugar” to instead recite that “this could be because of low blood sugar”, with the GUI 500 removing the emphasis and marking the edited text via italics.

In the illustrated example, the annotator has added to the recitation in the third representation 540c that the physician party “Advised patient to start Kyuritol” to state that this advice is “based on blood sugar test results”, which the GUI 500 indicates by marking the added text via italics.

In the illustrated example, the second representation 540b retains an error, indicating that the patient will start an allergy pill and vitamin D (using the future case) rather than indicating that the patient is currently has a regimen of taking an allergy pill and vitamin D, as indicated in the seventh segment 520d of the conversation. The annotator may have omitted a correction in this instance due to time constraints, not seeing the error, or judging the error minor enough to not require correction (e.g., as in both interpretations the patient will be taking the allergy pill and vitamin D in the future). In each of these scenarios, because to correction was made to the second representation 540b, the datasets for potentially retraining the sub-model used to generate the summary presented by the second representation 540b are not added to.

Accordingly, by directing the annotator's attention to the potential errors deemed most impactful to the end user, and dynamically updating which elements are emphasized, the GUI 500 can be used to gather improved data for the training and retraining of specific sub-models of the MLM used to generate the transcripts 160 and summaries 170 displayed therein, and reduces consumption of computing resources used to retrain those sub-models (e.g., reducing the amount of times retraining is triggered), among other benefits.

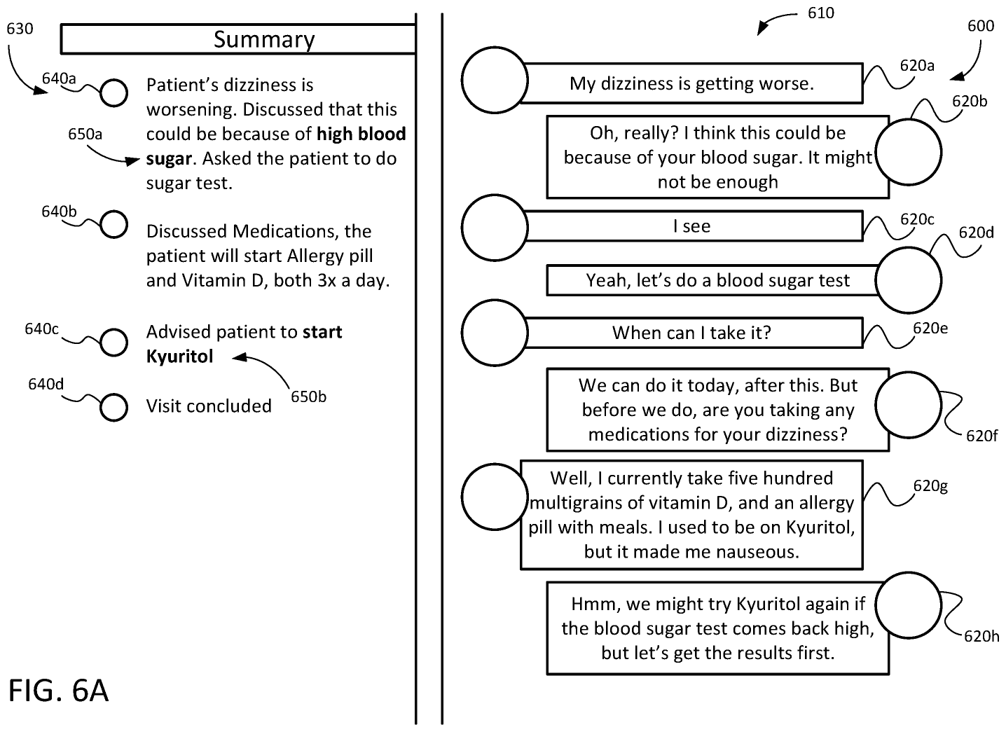

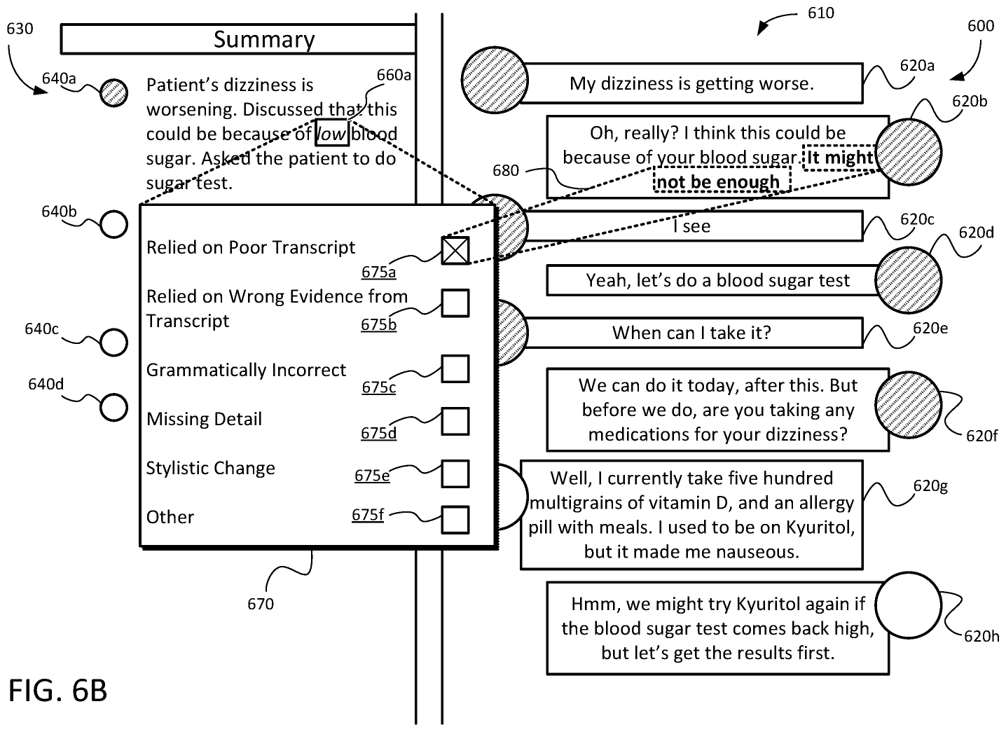

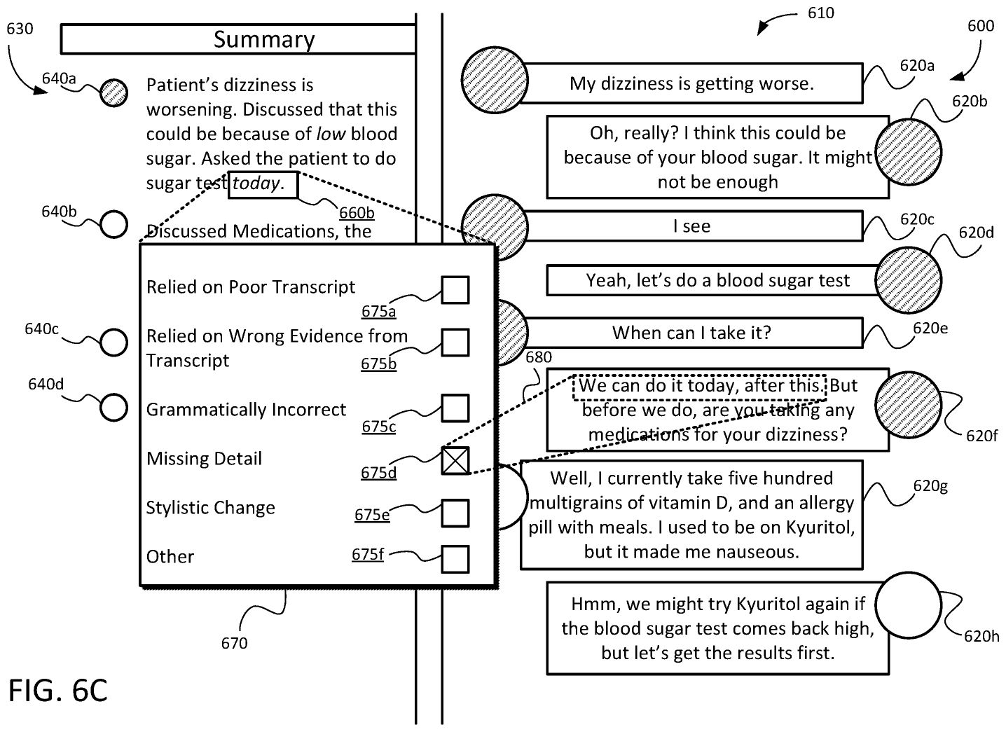

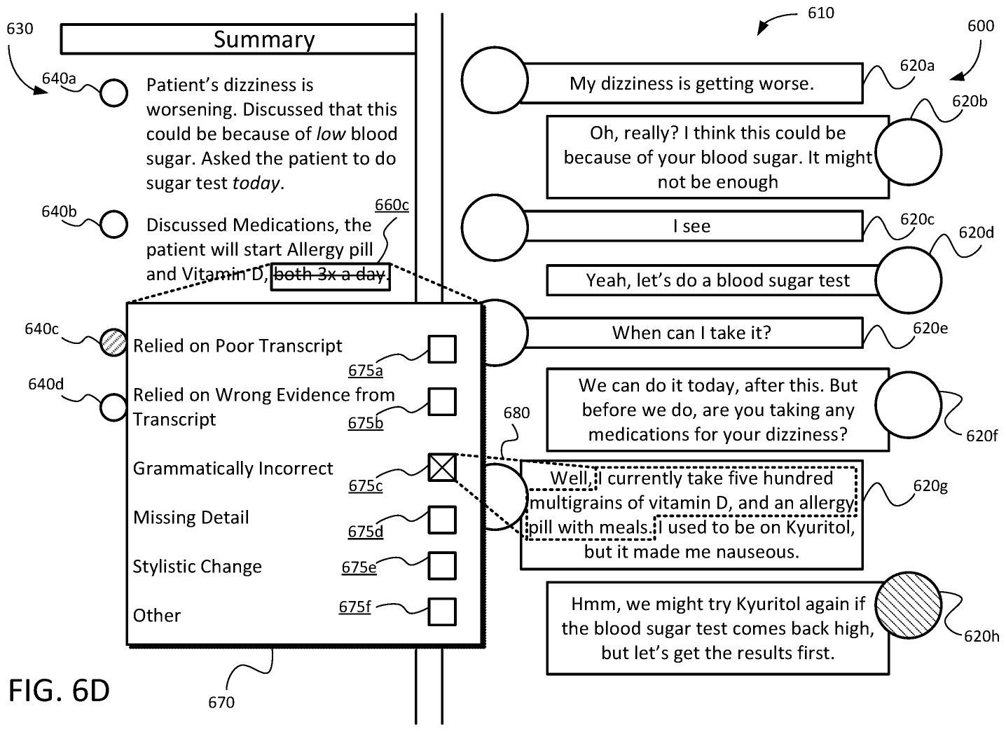

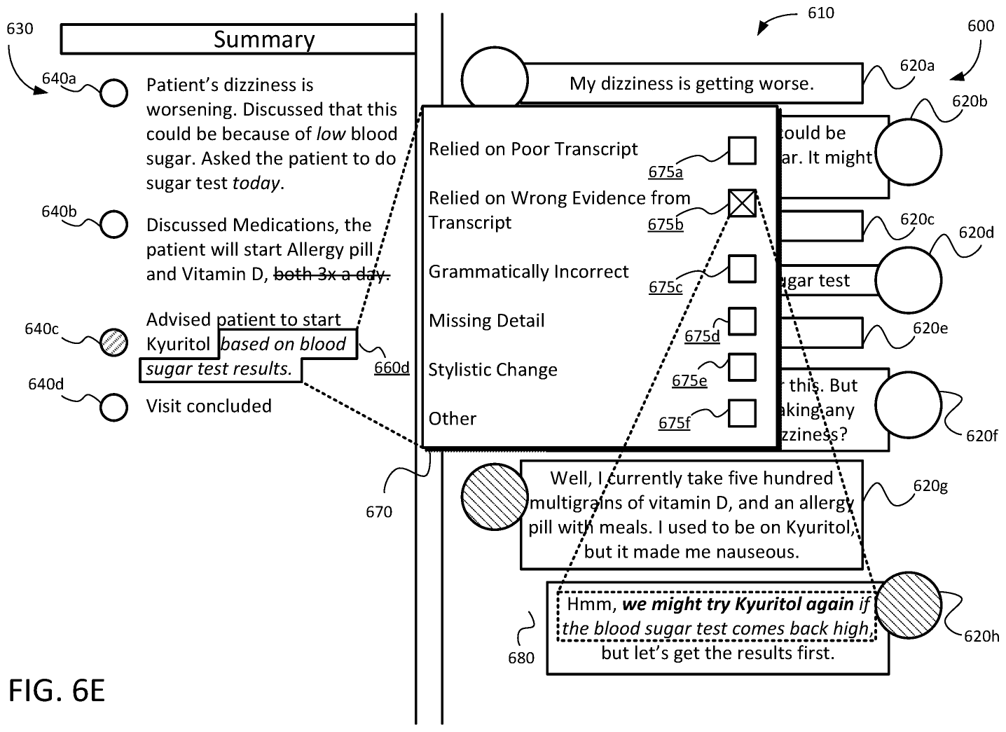

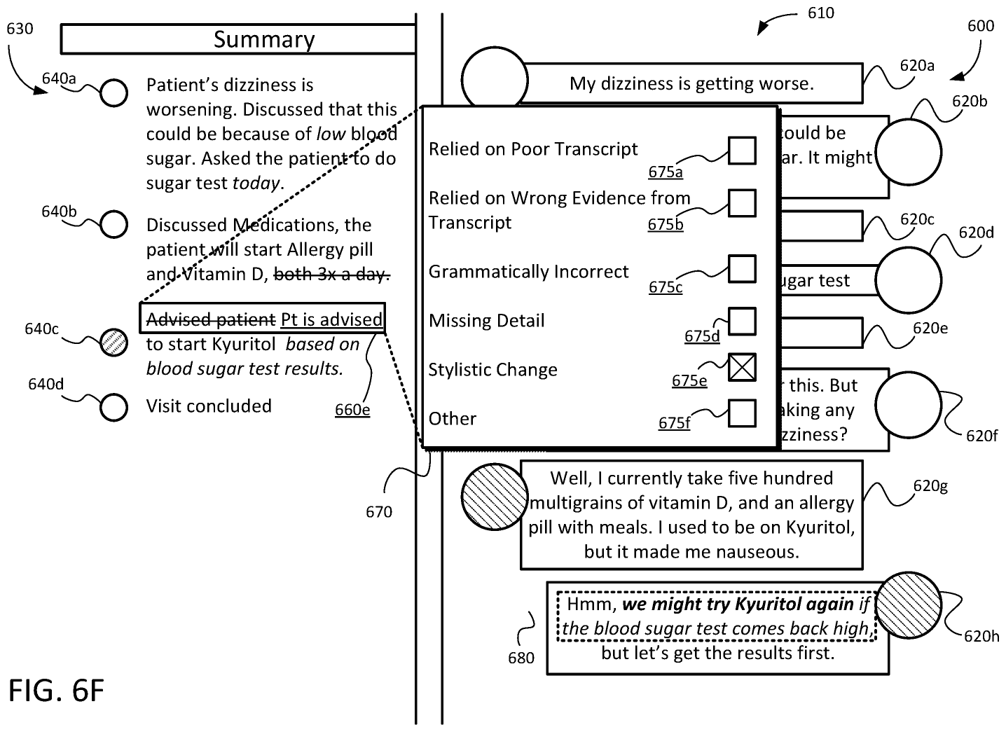

FIGS. 6A-6F illustrate UIs 600 with an annotator editing contents of a transcript 160 and summaries 170 thereof with initial edits made to the summaries 170, according to embodiments of the present disclosure. Using a conversation between a doctor and a patient as a non-limiting example, the GUI 600 illustrated in FIGS. 6A-6D shows a perspective for an annotator adapted interface, but in various embodiments, other conversations may relate to different conversational domains taken from different perspectives than those illustrated in the current example.

FIG. 6A illustrates a first state of the GUI 600, as may be provided to an annotator after initial analysis of an audio recording of a conversation by an NLP system 120. The transcript is shown in a transcript window 610, which includes several segments 620a-520h (generally or collectively, segment 620) identified within the conversation. In various embodiments, the segments 620 may represent speaker turns in the conversation, sentences identified in the conversation, topics identified in the conversation, a given length of time in the conversation (e.g., every X seconds), combinations thereof, and other divisions of the conversation.

Each segment 620 includes a portion of the written text of the transcript 160, and provides a UI element that allows the user to access the corresponding audio recording, make edits to the transcript, zoom in on the text, and otherwise receive additional detail for the selected portion of the conversation. The transcript illustrated in FIGS. 6A-6D may represent an entire conversation or a portion of the transcript such that the GUI 600 may omit portions of the transcript from initial display. For example, the GUI 600 may initially display only the segments 620 from which key terms or candidate terms appear (e.g., to skip introductory remarks or provide a summary), with the non-displayed segments 620 being omitted from display (e.g., positioned “off screen” for later access), shown as thumbnails, etc.

In various embodiments, additional data or metadata related to the segment 620 (e.g., speaker, topic, confidence in written text accurately matching input audio, whether edited by a user) can be presented based on color or shading of the segment 620 or alignment of the segment 620 in the transcript window 610. For example, the first segment 620a, third segment 620c, fifth segment 620e, and seventh segment 620g are shown as left-aligned versus the second segment 620b, fourth segment 620d, sixth segment 620f, and eighth segment 620h, which are shown as right-aligned, which indicates different speakers for the differently aligned segments 620. In another example, the seventh segment 620g is displayed with a different shading than the other segments 620, which may indicate that the NLP system is confident that human error is present in the third segment 320c, that the NLP system is not confident in the transcribed words matching the spoken utterance, or another aspect of the seventh segment 620g that deserves additional attention from the annotator.

Depending on the display area available to present the GUI 600, the transcript window 610 may include some or all of the segments 620 at a given time. Accordingly, although not illustrated, in various embodiments, the transcript window 610 may include various content controls (e.g., scroll bars, text size controls, etc.) to enable access to more content than can be legibly displayed at one time on the device outputting the GUI 600. For example, content controls can allow a user to scroll to currently off-screen elements, zoom in on elements below a size threshold or presented as thumbnails when not selected, or the like.

Outside of the transcript window 610, the GUI 600 displays a summary window 630 with one or more summarized representations 640a-d (generally or collectively, representation 640). The representations 640 provide summarizations of the key points extracted from the conversation and selectable controls that, in response to selection by a user, adjust the display of the segments 620 in the transcript window 610 to highlight the segments 620 on which the selected representation 640 is based. Accordingly, the representations 640 allow for easy navigation of the transcript based on the extracted summaries.

In FIG. 6A, various portions of the summary 170 in the representations 640 are provided with an emphasis effect applied thereto to draw the annotator's attention. For example, a first emphasized text 650a (generally or collectively, emphasized text 650) in the first representation 640a emphasizes the text of “high blood sugar” with a boldface effect, and a second empathized text 650b in the third representation 640c emphasizes the text of “start Kyuritol” with a boldface effect. In various embodiments, the text chosen to differentiate to draw the annotator's attention may be determined according to an emphasis registry 350 (discussed in greater detail in relation to FIG. 3) that identifies portions of or phrases in the transcript 160 or summary 170 that are to be scrutinized for accuracy at a higher degree than other portions/phrases based on end-user preferences, elements in which the MLM used to generate the transcript 160 and summary 170 has a confidence below a confidence threshold in the accuracy of transcription or summarization, that are potentially affected by an edit to an upstream element, and combinations thereof.

FIG. 6B shows the GUI 600 with emphases applied to phrases in the segments 620 related to a first edited element 660a (generally or collectively, edited element 660) from a summary displayed in the first representation 640a. As illustrated, an annotator has changed the phrase “high blood sugar” to read “low blood sugar”, with the edited element 660 removing the initial emphasis (e.g., boldface in FIG. 6A) and applying a different effect (e.g., italics in the present example) to identify what has been changed by the annotator.

A classification interface 670 is provided in the GUI 600 in response to the annotator editing the summary 170, which indicates the edited element(s) 660 and identifies the support 680 from the transcript 160 that the MLM used to generate the portion of the summary 170 to which the edited element(s) 660 is/are applied to. For example, the initial summary that the patient's dizziness could be worsening “because of high blood sugar” which the MLM initially determined based on the support 680 in the second segment 620 of “it might not be enough”.

In various embodiments, the annotator, can select from various classifications 675a-f (generally or collectively, classifications 675) to identify why the initial support 680 was incorrect or resulted in edits to the summary 170. In the illustrated examples, the first classification 675a indicates that a poor transcript was the source of the error in summarization, the second classification 675b indicates that the MLM selecting the wrong evidence from the transcript 160 was the source of the error in summarization, the third classification 675c indicates the MLM incorrectly parsing the grammar of a statement was the source of the error in summarization, the fourth classification 675d indicates that the MLM missed a detail from the conversation that the annotator added to the summary 170, and the fifth classification 675e indicates that the annotator's edits are stylistic in nature (rather than being substantive as in the other example classifications 675).

In various embodiments, more or fewer classifications with different error types (or combinations of error types) may be provided in a classification interface to the annotator to select between than are shown in FIGS. 6B-6F, which may be configured by an operator into various classifications (and descriptions thereof) that are useful to the end-user other than what are provided in the current examples. In various embodiments, providing the annotator with a specified set of options to choose between for the root causes of an error allows the MLM to distinguish various error types in summarization for use in building tailored datasets for retraining certain sub-models to avoid repeating certain errors. However, some edits may not fall into a recognized option, fall into more than one option, or not be recognized by an annotator as falling into a provided option, so an “other” option may be provided as a sixth classification 675f as a catch-all or fallback position for further analysis.

In the example shown in FIG. 6B, the annotator has selected the first classification 675a to indicate that the correction to the summary (e.g., the first edited element 660a) was to address a poor transcript. A poor transcript may be the result of the MLM not accurately representing what was spoken (e.g., poorly transcribing the conversation), an ambiguity in what was spoken, a term in the conversation being inaudible, or the like. Corrections for errors due to poor transcription may help retrain the sub-models to deal with ambiguities in conversations, gaps in the conversation, low accuracy transcripts, or to analyze a larger portion of the transcript for details before generating a summary (e.g., avoiding tunnel-vision in analysis of individual points). In the illustrated example, the phase “it might not be enough” may, on its own be ambiguously referring to the patient's blood pressure not being “high enough” or not being “low enough,” for which MLM initially selected (per the annotator's correction) the wrong interpretation. Accordingly, the annotator's correction can be used as part of a supervised (e.g., identifying “correct” analysis outputs) training dataset tailored to provide examples where the MLM is using a poor (e.g., ambiguous, inaccurate, gap-filled, etc.) transcript to produce more accurate summarizations of the conversation.

FIG. 6C shows the GUI 600 with an addition of a second edited element 660b that an annotator added to the summary included in the first representation 640a to indicate that the sugar test is to be performed “today”, which is indicated with a text effect (e.g., italics in the present example) to identify what has been added by the annotator.

Similarly to FIG. 6B, the GUI 600 in FIG. 6C provides a classification interface 670, in which the annotator has selected the fourth classification 675d to indicate that a detail was missing from the summary 170. In various embodiments, the annotator can select (or re-select) the evidence or support 680 from the transcript 160 that forms the basis of the edit made to the summary 170. In the case of an added detail, in which no evidence was initially used by the MLM as no element was initially generated by the MLM, the classification interface 670 may prompt the annotator to select one or more pieces of support 680 from the transcript 160 to provide as evidence for why the annotator added the edited element 660 to the summary 170.

In the illustrated example, the phase “We can do it today, after this” has been selected by the annotator as evidence or support 680 for the addition of the edited element 660b of “today” as a detail that was initially missing in the first representation 640a to indicate when the sugar test is to be performed. The annotator's correction and the selected support 680 can be used as part of a supervised (e.g., identifying “correct” analysis outputs) training dataset tailored to provide examples where the MLM omitting details that a human user would have included. Accordingly, the various sub-models of the MLM can be trained to add these additional details (and similar details) in the future; thereby countering tendencies in the training process that avoid negative reinforcement by providing shorter summaries that are too terse or otherwise sparse of details desirable to an end-user.

FIG. 6D shows the GUI 600 with the removal of a third edited element 660c from the summary included in the second representation 640b to indicate that patient may not be taking both the allergy pill and vitamin D three times a day. The removal of the third edited element 660c is presented in the GUI 600 with a different text effect from highlighted or added text (e.g., strikethrough in the present example), which allows the annotator during an annotating session to see the edited elements 660 that have been removed.

Similarly to FIG. 6B, the GUI 600 in FIG. 6D provides a classification interface 670, however, in response to editing the summary 170 in the second representation 640b, the annotator has selected the third classification 675c to indicate the MLM generated an erroneous summary 170 due to improper grammar. In various embodiments, annotator may select the option for improper grammar due to grammatical errors in the summary 170, improper interpretation of the grammar in the conversation, or an ambiguity in the summary 170 or transcript 160 that the annotator believes should not otherwise be included in the summary 170. The annotator can select (or re-select) the evidence or support 680 from the transcript 160 that forms the basis of the edit made to the summary 170. In the case of an improper grammar, the classification interface 670 may prompt the annotator to select one or more pieces of support 680 from the transcript 160 that supplied an ambiguous statement, support 680 from the transcript 160 that was misinterpreted to provide a grammatically incorrect summary 170, or support 680 from the transcript 160 from which the MLM should have generated the summary 170.

In the illustrated example, the phrase “I currently take five hundred multigrains of vitamin D, and an allergy pill with meals” has been selected by the annotator as potentially being grammatically incorrect to be represented as “both 3 times a day”. In the present example, the annotator may note that the number of meals that the patient cats per day is not clear from the conversation, nor is it clear whether the patient takes both the allergy pill and the vitamin D with every meals or at the same meals (e.g., taking vitamin D with breakfast and an allergy medication with dinner while skipping lunch may equally satisfy the statement as taking vitamin D and the allergy medication at breakfast, lunch, and dinner). Accordingly, the annotator has removed the edited element 660 that both are taken three times per day based on the ambiguous grammar indicated in the support 680.

The annotator's correction and the selected support 680 can be used as part of a supervised (e.g., identifying “correct” analysis outputs) training dataset tailored to provide examples where the MLM relies on ambiguously stated elements from the conversation or produces ambiguous or improperly states summaries 170. Accordingly, the various sub-models of the MLM can be trained to add these additional details (and similar details) in the future; thereby avoiding the generation of summaries 170 that are ambiguous or rely on ambiguously worded portions of the conversation or reducing the ambiguity present in the summaries 170.

FIG. 6E shows the GUI 600 in response to the annotator editing the third representation 640c, which was emphasized in FIG. 6A to highlight the text of “start Kyuritol”, to add corrective details that the advices to start Kyuritol was to be “based on blood sugar test results”, as indicated by the fourth edited element 660d, shown with a second text effect (e.g., italics).

Similarly to FIG. 6B, the GUI 600 in FIG. 6E provides a classification interface 670, however, in response to editing the summary 170 in the third representation 640c, the annotator has selected the second classification 675b to indicate the MLM generated an erroneous summary 170 due to relying on the wrong or incomplete evidence from the transcript 160.

In various embodiments, annotator may select the option for the MLM having used the wrong evidence when the MLM initially emphasizes the wrong portions of the conversation as the support 680, when the annotator identifies that the MLM has come to the wrong conclusion from the selected support 680, or when the MLM highlights an incomplete portion of the conversation as the support 680. The annotator can select (or re-select) the evidence or support 680 from the transcript 160 that the annotator identifies as the correct or more complete basis for the edited summary 160, and the classification interface 670 may prompt the annotator to select one or more pieces of support 680 from the transcript 160 when the annotator select a classification 675 that the edit is to correct an error in the evidence that the MLM used.

In the illustrated example, the phase “we might try Kyuritol again if the blood sugar test comes back high” has been selected by the annotator as potentially being the support 680 for the edit that the initial summary 170 in the third representation 640c used the wrong evidence from the transcript 160. In the present example, the portions of the selected support 680 that the MLM initially selected to generate the initial summary 170 (e.g., as shown in FIG. 6A) are shown with a first text effect (bold), while the portions of the support 680 selected by the annotator are shown with a second text effect (italics), in which the portions being both selected by the MLM and the annotator have both text effects applied in the GUI 600 (e.g., bold and italics).

The annotator's correction and the selected support 680 can be used as part of a supervised (e.g., identifying “correct” analysis outputs) training dataset tailored to provide examples where the MLM relied on incorrect or incomplete evidence.

Accordingly, the various sub-models of the MLM can be trained to add these additional details (and similar details) in the future or make better (or more accurate) selections for which support 680 to treat as evidence for a summary 170; thereby generating improved summaries that more closely match what a human user might identify as important to summarize.

FIG. 6F shows the GUI 600 in response to the annotator editing the third representation 640c to add address a stylistic error in the third representation, for how the advice and object of the advice are addressed, as indicated by the fifth edited element 660e replacing the original text of “Advised patient” to “Pt is advised”, shown with second text effects (e.g., italics for added text and strikethrough for removed text).

Similarly to FIG. 6B, the GUI 600 in FIG. 6E provides a classification interface 670, however, in response to editing the summary 170 in the third representation 640c, the annotator has selected the sixth classification 675e to indicate the MLM generated a summary 170 that was factually correct, but was corrected to provide a preferred style of presenting the factual data (e.g., a semantically similar arrangement).

In various embodiments, annotator may select the option for the MLM having generated a stylistically incorrect, or less preferred, representation when the MLM initially produced a factually correct output in a way that a human user would not, or in a format that is not preferred by the end user. For example, by switching the order of “advised” and “patient”, the reader may more quickly recognize who the advice is for (e.g., did the patient advice the provider of a condition, or was the patient advised by the provider?), and by using the shorthand “Pt” in place of the long form “patient”, the reader may be able to more quickly skim the summary for relevant details.

By indicating that the edits were stylistic, rather than substantive, the annotator provides negative feedback to the sub-models used for output generation (rather than the sub-models used for parsing the conversation, or as positive feedback for those sub-models) for the initial output, and provides a positive example for how to format the data in the future. Accordingly, when presented with similar inputs in the future, the MLM can be trained with the stylistic feedback to adjust the output of the summary 170 to use the preferred style guidance from the annotator to generate more humanlike outputs or outputs that meet the style guidelines preferred by the end-user, without negatively affecting the sub-models used to identify the underlying facts and data used to generate the summary 170.

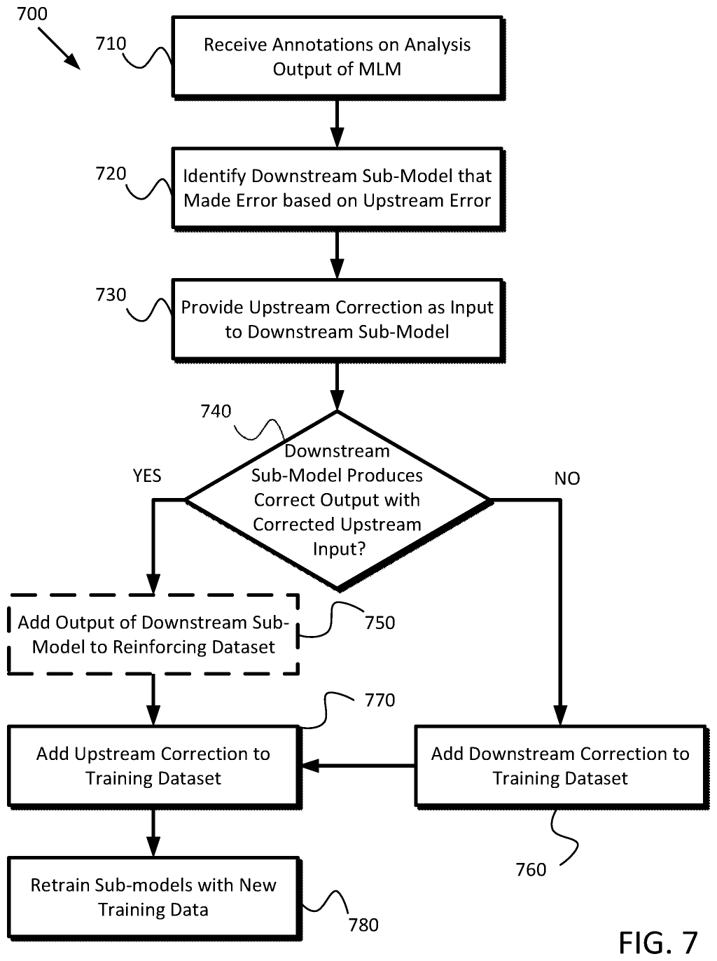

FIG. 7 is a flowchart of an example method 700 for handling multi-loop feedback for machine learning model pipelines, according to embodiments of the present disclosure. Method 700 begins with block 710, where an MLM receives annotations on any analysis output previously generated by the MLM. In various embodiments, the feedback includes edits or annotations made to the content of a transcript of a conversation, the content of a summarization of the transcript, and combinations thereof. In various embodiments, the actions ascribed to the MLM may be performed by a supervisor module that identifies portions of the inputs used by the MLM to generate various outputs and determines whether to retrain the MLM or sub-models thereof using the newly collected examples in addition to or alternatively from previously collected training data. Each of the individual annotations to the model are handled as corrections to an underlying or initial version of the outputs generated by the MLM, which is classified as an error made by the MLM.

At block 720, the MLM identifies a sub-model of the MLM that made an error based on an error from an upstream sub-model in a pipeline for analysis within the MLM. For example, the MLM may be made of several individual MLMs that operate in a pipeline as sub-models of the overarching MLM used to analyze data. These sub-models may generate various outputs that are used by other sub-models as inputs. Accordingly, when a first sub-model is identified as generating an output that was corrected (e.g., that was initially in error) and that was provided as an (erroneous) input to a second sub-model that also produced an output that was corrected by an annotator, the second sub-model is identified as a sub-model of the MLM that made an error based on an error from an upstream sub-model. For example, when a summary generated by a summary generating sub-model is corrected by an annotator, and the summary generating sub-model used a portion of a transcript generated by a transcription model as an input, in which the annotator also corrected the portion of the transcript, the summary generating sub-model is identified as having made an error based on an upstream error.

In some embodiments, an individual sub-model may use sequences of input data to generate an output over a rolling window, and may therefore be downstream (and upstream) to itself. For example, when identifying a topic of a conversation, a topic identification sub-model may take three sequential sentences from a transcript as input to ascribe a topic classification to the third sentence using the content of the three sentences and the topic classifications previously ascribed to the first and second sentences. Accordingly, an edit to the ascribed topic for the first or second sentences can be identified as an error from an “upstream” sub-model as the example sub-model feeds its outputs back into its analysis process as inputs.

At block 730, the MLM provides the first correction to the output of the upstream sub-model as an input to the sub-model identified per block 720. In various embodiments, the downstream sub-model may receive additional inputs for use with the first correction when generating an output, which may include additional corrections from the same or different upstream sub-models. In some embodiments, the MLM may evaluate the downstream model using only one correction at a time, or multiple corrections only if those multiple corrections are received from a single upstream sub-model.

At block 740, the MLM determines whether the downstream sub-model, when provided with the first correction (per block 730 from the upstream sub-model), produces a correct result matching a second correction to the initial output of the downstream sub-model. For example, when the upstream sub-model initially produced output A, which was corrected to output B by an annotator, and the downstream sub-model initially produced (when using output A as an input) output C, which was corrected to output D by an annotator, the MLM determines whether the downstream sub-model produced output D when provided with output B as in input instead of input A. When the downstream sub-model produces the corrected result when provided the correct inputs (e.g., B→D), the method 700 proceeds to block 750. Otherwise, when the downstream sub-model does not produce the corrected result when provided the correct inputs (e.g., B→!D), the method 700 proceeds to block 760

At block 750, which may optionally performed or omitted in various embodiments, the MLM adds the initially correct output of the downstream sub-model, and associated inputs to a reinforcing dataset of positive examples. In various embodiments, the positive examples can include examples for the sub-model that received no correction or that were confirmed by the annotator as being correct that were not based on upstream errors. In some embodiments, the positive examples can include linked elements (as inputs or related outputs) that include errors corrected elsewhere by the annotator.

At block 760, in response to the MLM determining that the downstream sub-model did not produce the correct output (or a near match thereto) when supplied with the corrected input (e.g., the corrected output of an upstream sub-model), the MLM adds the correction made to the output of the downstream sub-model to a training dataset. In various embodiments, one or both of the initially incorrect output based on the initially incorrect input and the subsequently incorrect output based on the subsequently correct input are added as negative examples to retrain the downstream sub-model.

At block 770, the MLM adds the correction made to the output of the upstream sub-model to a training dataset. In various embodiments, when the upstream sub-model is downstream from another model the MLM may omit adding the correction to the training dataset if previously added in an earlier iteration of block 760, thereby avoiding duplication in the training dataset.

At block 780, the MLM retrains the sub-models with new training data (e.g., added per blocks 750, 760, or 770). In various embodiments, the MLM determines to retrain the sub-model once a threshold amount of new training data are collected, and waits to retrain the sub-models until sufficient new training data are collected. In various embodiments, the MLM may retrain some or a subset of the sub-models, thereby focusing computing resources on the sub-models most in need of retraining (and having the largest negative effect on output accuracy) while conserving resources by not retraining sub-models that are operating more closely to a desired output style.

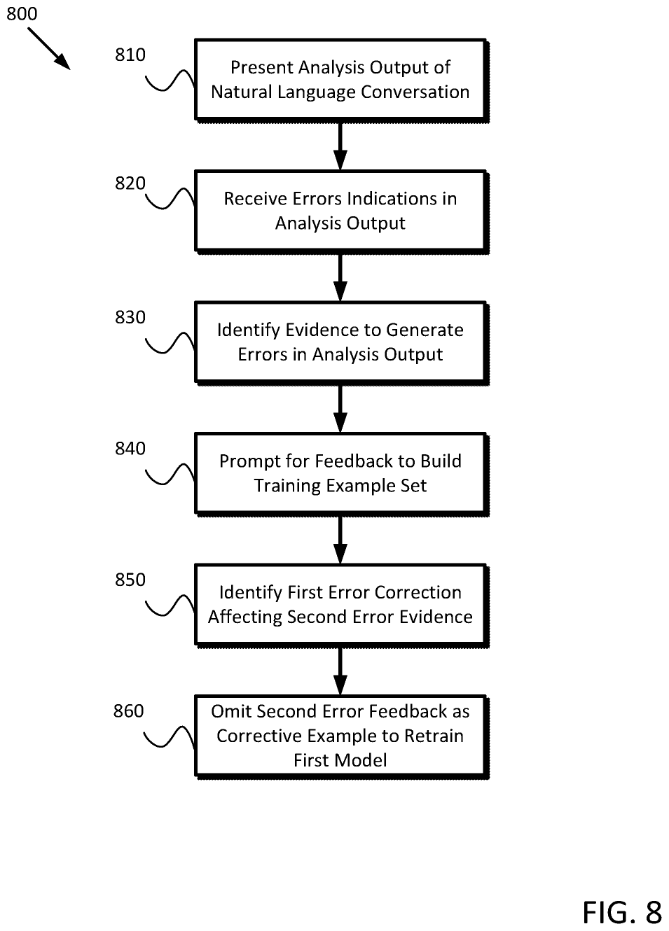

FIG. 8 is a flowchart of an example method 800 for handling multi-loop feedback for machine learning model pipelines, according to embodiments of the present disclosure. Method 800 begins at block 810, where a user device presents, via a GUI, the analysis output of a natural language conversation created by a MLM. In various embodiments, the analysis output includes one or more of a transcript of the spoken natural language conversation and a summary (or multiple summaries) of the natural language conversation.

At block 820, the user device receives, via the GUI, error indications in the analysis output. In various embodiments, the error indications identify portions of the analysis output that are not correct per the annotator's assessment, which may include factual errors, errors in transcription, and errors in interpretation on the part of the MLM as judged by the annotator. Additionally, the error indications can also identify stylistic errors including ambiguities, the use of non-preferred terminology (e.g., a summary of a conversation that includes a scientific term and a non-scientific term for an entity selecting a correct term for the entity, but not the preferred term), or awkward phrasing that the annotator assesses as needing correction despite being technically correct.

At block 830, the user device (or the MLM) identifies in the UI the evidence used by the MLM to generate the errors identified (per block 820) in the analysis output. In various embodiments, the MLM identifies the sub-models used to generate the analysis output identified as containing an error and traces back the inputs used by the various sub-models until a designated level of input is reached. For example, when identifying the evidence used by a transcription MLM, the MLM may identify the audio in a recording of a conversation being transcribed (and surrounding audio) as the evidence for generating a given length of transcript. In another example, when identifying the evidence used by a summarization MLM, the MLM may identify the portions of a written transcript of a conversation being summarized (and surrounding sentence) as the evidence for generating a given summary.

The evidence identified by the MLM to generate the indicated errors in the analysis output may be identified in the GUI to the annotator using various formats. For example, when the annotator identifies an error in a summary or transcript, the GUI can draw attention to the portions of the transcript used by the MLM in generating the error via applying a text effect, highlighting, changes in font size, or the like. In various embodiments, when multiple errors are identified, different techniques can be used to identify the evidence associated with certain errors, so that, for example, in response to a user indicating a first error associated with first initial evidence and a second error associated with second initial evidence in the analysis output are identified, respectively, by a first text effect and a second text effect in the GUI, or are identified at different times in the GUI.

At block 840, the user device prompts, via the GUI, the annotator for feedback on the error. The feedback for a given error includes a correction to the error (e.g., what the analysis output should be), a category or type for the error (e.g., reliance on incorrect or poor transcript, reliance on wrong evidence selected by MLM, grammatically incorrect, missing details, too many details, other, etc.), and corrective evidence (when available or relevant) that the annotator relies on in suggesting the correction to change the initial analysis output. The user device may prompt the annotator for different sets of feedback for different edits/errors in response to the annotator making the correction before the annotator can identify the next error to correct, or may wait until the annotator has completed review of the analysis output.

These errors, their labels, and the corrections to the errors are gathered for potential use in retraining the MLM to more accurately mimic the performance of a human user, for example in analyzing and summarizing a transcript of a natural language conversation.

At block 850, the user device or the MLM identifies a first correction to a first error that affects the evidence used by the MLM in generating a section of the analysis output for which the annotator made a second correction. Although referenced as “first” and “second” errors and corrections, in various embodiments, the errors and associated corrections may occur in any order.

At block 860, the user device or the MLM omits (or removes) the second error and the associated feedback as a corrective example for retraining the models. Because the second error was based on evidence from a portion of the analysis output that was initially incorrect (e.g., being corrected by the first correction), any corrections based on that error may not be usable for improving the performance of the affected responsible model. For example, when the first correction is to a portion of a transcript generated by a first sub-model used by a downstream sub-model to generate a summary of the transcript, which received a second correction, the second error and feedback may no longer be relevant to improve the accuracy of the downstream sub-model. Because the second feedback may no longer be unusable or is duplicative of the first feedback for the first error, in some embodiments, the second error and second feedback are omitted or removed from the training dataset as a corrective (e.g., negative) example.

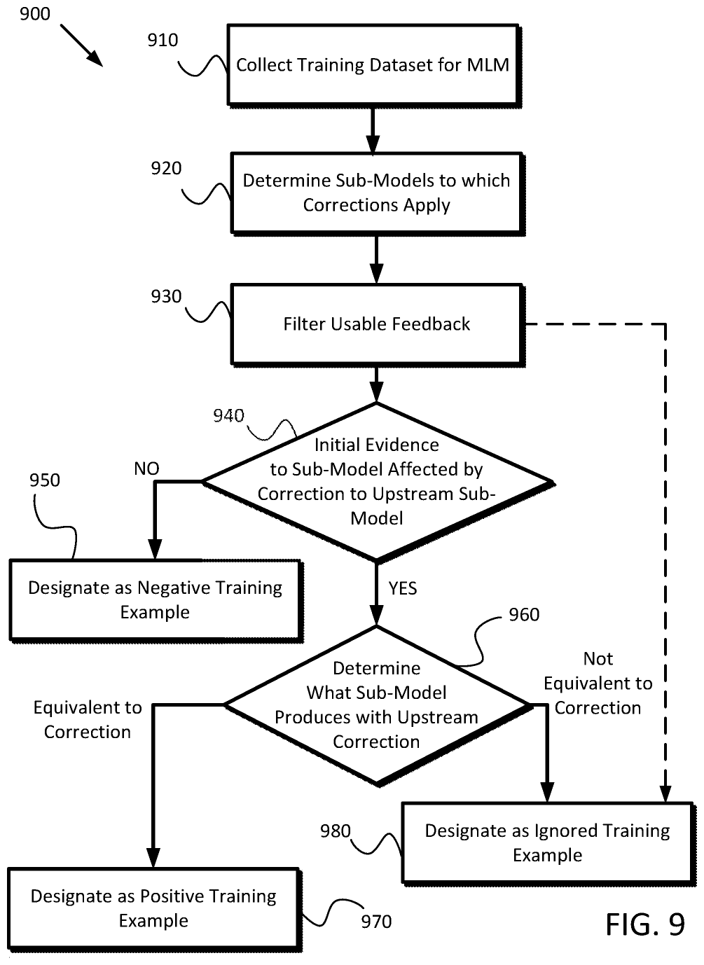

FIG. 9 is a flowchart of an example method 900 for handling multi-loop feedback for machine learning model pipelines, according to embodiments of the present disclosure. Method 900 begins at block 910, where a system collects a training dataset for an MLM. When the MLM is a pipelined MLM that includes a plurality of sub-models with defined functions that produce outputs that may be used as inputs for other sub-models in the pipelined MLM, some examples in the training dataset may be relevant to different sub-models.

Additionally, not all corrections may be valuable for use in retraining the various sub-models. For example, some corrections may be made to the output of a sub-model that was provided an “incorrect” or “bad” input, but the underlying sub-model may be well-trained and would have produce a “correct” or “good” output but for an error in an upstream sub-model in the pipeline. In another example, some corrections may be to non-sequiturs, asides, or other portions of a conversation that, although useful for improving the analysis output, are not valuable in re-training the sub-models. Accordingly, once the candidate training set is collected, method 900 may proceed to blocks 920-980 for each candidate example to classify how or whether to use the corrections in re-training portions of the MLM.

At block 920, the system determines the sub-models within the MLM to which various corrections in the candidate training set apply to. In various embodiments, an annotator may provide, as part of the corrective feedback, various tags or evidence for why a correction was made. These tags and correction types can identify which sub-models are most responsible for the originally erroneous output, which drew the correction. For example, the original phrase of “Return phone call tomorrow” may be corrected to “Return phone call on March 11” for either lack of specificity (e.g., “tomorrow” may correct if the conversation took place on March 10) or for identifying the wrong date (e.g., the MLM misidentified the day to call back as “tomorrow” and should have chosen “March 11”), which may indicate different sub-models as the source of the error. Accordingly, the feedback from the annotator includes tags that allow the MLM to partition the training dataset into sub-sets that correspond to the different sub-models that may be affected by the corrections. In various embodiments, one correction may be partitioned into zero, one, or multiple sub-sets for use in retraining individual sub-models.

At block 930, the system filters the dataset for usable feedback from the corrections. In various embodiments, certain corrections may be valid and improve the analysis output, but are not useful in improving the accuracy of the sub-models. For example, the phrase “He is a good boy” in a summary may be corrected to “Patient owns a dog”. In various embodiments, corrections may be filtered out of the training dataset when the correction is identified by the annotator as being off-topic, when the MLM identifies the original analysis output or the correction as being related to a different topic than surrounding outputs, when the correction differs from the original output by a predefined difference score (e.g., as determined via Euclidean distance, cosine similarity, Pearson's correlation, etc. on vector representations of the edited and unedited sections), and the like. Usable feedback is subject to further analysis per blocks 940-980, while non-usable feedback may be ignored, discarded, or added as an ignored training exampled per block 980.

At block 940, the system determines whether the sub-model under consideration is potentially affected by feedback and corrections applied to an upstream sub-model. For example, when an upstream sub-model initially produced an output used as an input by a downstream sub-model and both the upstream sub-model and the downstream sub-model received corrections affecting the respective outputs, the downstream sub-model may be identified as being affected by the correction to the upstream sub-model. In various embodiments, the MLM may identify any sub-model receiving an input from an upstream sub-model in a chain of sub-models as being potentially affected, or may restrict the effect to those downstream sub-models within N hops of a directly corrected sub-model as being potentially affected. When the sub-model under analysis is determined to have been affected by a correction to an upstream sub-model, method 900 proceeds to block 960. Otherwise, method 900 proceeds to block 950.

At block 950, in response to determining that the sub-model has not received in input from another sub-model that was also corrected, the MLM designates the feedback as a negative training example for use in retraining the sub-model to avoid producing the initial output (and to favor producing the corrected output) when presented with the initial inputs.

At block 960, in response to determining that the sub-model has received in input from another sub-model that was also corrected, the system determines what the sub-model under consideration would have produced if the upstream sub-models had initially produced correct outputs. When the sub-model produces an input equivalent to the correction when provided with the correct inputs (e.g., the corrected outputs from the upstream sub-model), method 900 proceeds to block 970. Otherwise, method 900 proceeds to block 980.

At block 970, in response to determining that the sub-model produces an equivalent output to the correction when provided with corrected inputs, the system designates the example as a positive training example. The positive training example is used during retraining the sub-model to encourage the sub-model to produce the output given the corrected inputs or altered evidence.

At block 980, in response to determining that the sub-model does not produce an equivalent output to the correction when provided with corrected inputs, the system designates the example as an ignored training example that is not to be used in retraining the model.

FIG. 10 illustrates physical components of an example computing device 1000 according to embodiments of the present disclosure. The computing device 1000 may include at least one processor 1010, a memory 1020, and a communication interface 1030.

The processor 1010 may be any processing unit capable of performing the operations and procedures described in the present disclosure. In various embodiments, the processor 1010 can represent a single processor, multiple processors, a processor with multiple cores, and combinations thereof.

The memory 1020 is an apparatus that may be either volatile or non-volatile memory and may include RAM, flash, cache, disk drives, and other computer readable memory storage devices. Although shown as a single entity, the memory 1020 may be divided into different memory storage elements such as RAM and one or more hard disk drives. As used herein, the memory 1020 is an example of a device that includes computer-readable storage media, and is not to be interpreted as transmission media or signals per se.

As shown, the memory 1020 includes various instructions that are executable by the processor 1010 to provide an operating system 1022 to manage various features of the computing device 1000 and one or more programs 1024 to provide various functionalities to users of the computing device 1000, which include one or more of the features and functionalities described in the present disclosure. One of ordinary skill in the relevant art will recognize that different approaches can be taken in selecting or designing a program 1024 to perform the operations described herein, including choice of programming language, the operating system 1022 used by the computing device, and the architecture of the processor 1010 and memory 1020. Accordingly, the person of ordinary skill in the relevant art will be able to select or design an appropriate program 1024 based on the details provided in the present disclosure.

Additionally, the memory 1020 can include one or more of machine learning models 1026 for speech recognition and analysis, as described in the present disclosure. As used herein, the machine learning models 1026 may include various algorithms used to provide “artificial intelligence” to the computing device 1000, which may include Artificial Neural Networks, decision trees, support vector machines, genetic algorithms, Bayesian networks, or the like. The models may include publically available services (e.g., via an Application Program Interface with the provider) as well as purpose-trained or proprietary services. One of ordinary skill in the relevant art will recognize that different domains may benefit from the use of different machine learning models 1026, which may be continuously or periodically trained based on received feedback. Accordingly, the person of ordinary skill in the relevant art will be able to select or design an appropriate machine learning model 1026 based on the details provided in the present disclosure.

The communication interface 1030 facilitates communications between the computing device 1000 and other devices, which may also be computing devices 1000 as described in relation to FIG. 10. In various embodiments, the communication interface 1030 includes antennas for wireless communications and various wired communication ports. The computing device 1000 may also include or be in communication, via the communication interface 1030, one or more input devices (e.g., a keyboard, mouse, pen, touch input device, etc.) and one or more output devices (e.g., a display, speakers, a printer, etc.).

Accordingly, the computing device 1000 is an example of a system that includes a processor 1010 and a memory 1020 that includes instructions that (when executed by the processor 1010) perform various embodiments of the present disclosure. Similarly, the memory 1020 is an apparatus that includes instructions that when executed by a processor 1010 perform various embodiments of the present disclosure.

Programming modules, may include routines, programs, components, data structures, and other types of structures that may perform particular tasks or that may implement particular abstract data types. Moreover, embodiments may be practiced with other computer system configurations, including hand-held devices, multiprocessor systems, microprocessor-based or programmable user electronics, minicomputers, mainframe computers, and the like. Embodiments may also be practiced in distributed computing environments where tasks are performed by remote processing devices that are linked through a communications network. In a distributed computing environment, programming modules may be located in both local and remote memory storage devices.

Furthermore, embodiments may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Embodiments may also be practiced using other technologies capable of performing logical operations such as, for example, AND, OR, and NOT, including, but not limited to, mechanical, optical, fluidic, and quantum technologies. In addition, embodiments may be practiced within a general purpose computer or in any other circuits or systems.

Embodiments may be implemented as a computer process (method), a computing system, or as an article of manufacture, such as a computer program product or computer-readable storage medium. The computer program product may be a computer-readable storage medium readable by a computer system and encoding a computer program of instructions for executing a computer process. Accordingly, hardware or software (including firmware, resident software, micro-code, etc.) may provide embodiments discussed herein. Embodiments may take the form of a computer program product on a computer-usable or computer-readable storage medium having computer-usable or computer-readable program code embodied in the medium for use by, or in connection with, an instruction execution system.

Although embodiments have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage medium does not include computer-readable transmission media.

Embodiments described in the present disclosure may be used in various distributed computing environments where tasks are performed by remote processing devices that are linked through a communications network.

Embodiments described in the present disclosure may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 1000 or any other computing devices, in combination with computing device 1000, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described embodiments.

The descriptions and illustrations of one or more embodiments provided in this application are intended to provide a thorough and complete disclosure of the full scope of the subject matter to those of ordinary skill in the relevant art and are not intended to limit or restrict the scope of the subject matter as claimed in any way. The embodiments, examples, and details provided in this disclosure are considered sufficient to convey possession and enable those of ordinary skill in the relevant art to practice the best mode of the claimed subject matter. Descriptions of structures, resources, operations, and acts considered well-known to those of ordinary skill in the relevant art may be brief or omitted to avoid obscuring lesser known or unique aspects of the subject matter of this disclosure. The claimed subject matter should not be construed as being limited to any embodiment, aspect, example, or detail provided in this disclosure unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently.

Having been provided with the description and illustration of the present disclosure, one of ordinary skill in the relevant art may envision variations, modifications, and alternative embodiments falling within the spirit of the broader aspects of the general inventive concept provided in this disclosure that do not depart from the broader scope of the present disclosure.

As used in the present disclosure, a phrase referring to “at least one of” a list of items refers to any set of those items, including sets with a single member, and every potential combination thereof. For example, when referencing “at least one of A, B, or C” or “at least one of A, B, and C”, the phrase is intended to cover the sets of: A, B, C, A-B, B-C, and A-B-C, where the sets may include one or multiple instances of a given member (e.g., A-A, A-A-A, A-A-B, A-A-B-B-C-C-C, etc.) and any ordering thereof.

As used in the present disclosure, the term “determining” encompasses a variety of actions that may include calculating, computing, processing, deriving, investigating, looking up (e.g., via a table, database, or other data structure), ascertaining, receiving (e.g., receiving information), accessing (e.g., accessing data in a memory), retrieving, resolving, selecting, choosing, establishing, and the like.

The following claims are not intended to be limited to the embodiments shown herein, but are to be accorded the full scope consistent with the language of the claims. Within the claims, reference to an element in the singular is not intended to mean “one and only one” unless specifically stated as such, but rather as “one or more” or “at least one”. Unless specifically stated otherwise, the term “some” refers to one or more. No claim element is to be construed under the provision of 35 U.S.C. § 112(f) unless the element is expressly recited using the phrase “means for” or “step for”. All structural and functional equivalents to the elements of the various embodiments described in the present disclosure that are known or come later to be known to those of ordinary skill in the relevant art are expressly incorporated herein by reference and are intended to be encompassed by the claims. Moreover, nothing disclosed in the present disclosure is intended to be dedicated to the public regardless of whether such disclosure is explicitly recited in the claims.

1. A method of training a machine learning model (MLM) that has a plurality of sub-models arranged in a sequential pipeline, comprising:
receiving annotations regarding an analysis output of the MLM for a recording of a natural language conversation, wherein the annotations include at least a first correction to a first error in the analysis output and a second correction to a second error in the analysis output;
identifying, a first sub-model of the plurality of sub-models that is responsible for the first error and a second sub-model of the plurality of sub-models that is responsible for the second error, wherein the first sub-model occurs earlier in the sequential pipeline than the second sub-model;
determining whether the second sub-model, when provided with a first corrected output from the first sub-model based on the first correction produces the second correction as part of a second corrected output from the second model; and
in response to determining that the second model produces the second corrected output, retraining only the first sub-model based on the first correction.

2. The method of claim 1, wherein:
the first correction indicates: a first location of the first error in a transcript of the natural language conversation included in the analysis output, a first category of the first error, and a first timestamp in the recording locating a first evidence supporting the first correction to replace the first error; and
the second correction indicates: a second location of the second error in the transcript, a second category of the second error, and a second timestamp in the recording locating a second evidence supporting the second correction to replace the second error.

3. The method of claim 2, wherein the second timestamp occurs earlier in the recording than the first timestamp.

4. The method of claim 2, wherein at least one of: the first location, the first category, and the first timestamp at least partially overlap with at least one of: the second location, the second category, and the second timestamp.

5. The method of claim 1, wherein an initial first evidence used by the MLM to initially generate the first error occurs later in the recording than an initial second evidence used by the MLM to initially generate the second error.

6. The method of claim 1, wherein the sequential pipeline includes, in sequence: a word identification sub-model, a categorization identification sub-model, a summary generation sub-model, and an action identification sub-model.

7. The method of claim 1, further comprising discarding the second correction from a training dataset before retraining the MLM.

8. The method of claim 1, further comprising retraining the second sub-model based on the second correction.

9. The method of claim 1, wherein the analysis output includes a transcript of the recording and a summary of the natural language conversation.

10. A method, comprising:
presenting, via a user interface (UI), an analysis output of a natural language conversation created by a machine learning model (MLM);
in response to a user indicating a first error and a second error in the analysis output via the UI, identifying a first initial evidence and a second initial evidence in a transcript included in the analysis output, wherein the first initial evidence was used by the MLM to generate the first error and the second initial evidence was used by the MLM to generate the second error;
prompting, via the UI, for the user to indicate a first feedback that includes: a first correction to the first error, a first category of the first error, and a first timestamp in the natural language conversation for a first corrective evidence supporting the first correction to replace the first error, wherein the first corrective evidence is different from the first initial evidence;
prompting, via the UI, for the user to indicate a second feedback that includes: a second correction to the second error, a second category of the second error, a second timestamp in the natural language conversation for a second corrective evidence supporting the second correction to replace the second error, wherein the second corrective evidence is different from the second initial evidence; and
in response to identifying that first correction affects at least one of the second initial evidence and the second corrective evidence, providing the first feedback as a corrective example for retraining the MLM.

11. The method of claim 10, further comprising, in response to determining that a sub-model of the MLM used to generate the second error would have generated an initial output matching the second correction had the sub-model been provided with the first correction rather than the first error as an initial input, providing the second feedback as a reinforcing example for retraining the MLM.

12. The method of claim 10, further comprising: in response to identifying that second correction affects neither the first initial evidence nor the first corrective evidence, discarding the second feedback when retraining the MLM.

13. The method of claim 10, further comprising: in response to identifying that second correction affects at least one of the first initial evidence and the first corrective evidence, providing the second feedback as a second corrective example for retraining the MLM.

14. The method of claim 10, wherein the user further indicates a third error in the analysis output of the natural language conversation, identifying in the user interface (UI) a third initial evidence in the transcript that was used by the MLM to generate the third error, the method further comprising:
prompting, via the UI, for the user to indicate a third feedback that includes: a third correction to the third error, a third category of the third error, a third timestamp in the natural language conversation for a third corrective evidence supporting the third correction to replace the third error, wherein the third corrective evidence is different from the third initial evidence
in response to identifying that neither the first correction nor the second correction affects at least one of the third initial evidence or the third corrective evidence, providing the third feedback as an additional corrective example for retraining the MLM.

15. The method of claim 10, wherein the first corrective evidence is different from the first initial evidence and shares an overlapping portion with the first initial evidence.

16. A method, comprising:
collecting a training dataset for a machine learning model (MLM) for generating an analysis output of a natural language conversation, the MLM comprising a plurality of sub-models arranged in a sequential pipeline, the training dataset including a plurality of example corrections to previous analysis outputs generated by the MLM;
for each example included in the training dataset:
determining which sub-model of the plurality of sub-models each example provides a correction to;
determining whether an initial input for each example is affected by an upstream correction indicated in a different example that provides an altered input to the sub-model according to the different correction;
designating in the training dataset:
a negative training example when the initial input is not affected by the different correction;
a positive training example when the initial input is affected by the different correction and the sub-model that the example provides the correction to produces equivalent outputs when analyzing the initial input and the altered input; and
an ignored training example when the initial input is affected by the correction and the sub-model that the example provides the correction to produces different outputs when analyzing the initial input and the altered input; and
retraining the MLM using the training dataset.
